(19) United States
(12) Patent Application Publication
(10) Pub. No.: US 2020/0033586 A1
(43) Pub. Date: Jan. 30, 2020

(54) EYEPIECE AND DISPLAY APPARATUS

(71) Applicant: SONY CORPORATION, TOKYO (JP)

(72) Inventors: MAMORU SUZUKI, KANAGAWA (JP); TAKEO ARAI, AICHI (JP); TAKATOSHI MATSUYAMA, AICHI (JP)

(21) Appl. No.: 16/500,968

(22) PCT Filed: Mar. 5, 2018
(86) PCT No.: PCT/JP2018/008236

§ 371 Date: Oct. 4, 2019

(30) Foreign Application Priority Data
Apr. 13, 2017 (JP) 2017-079778

(51) Int. Cl. G02B 25/00; G02B 9/04; G02B 9/12; G02B 13/18

(52) U.S. Cl. CPC G02B 25/001; G02B 13/18; G02B 9/12; G02B 9/04

(57) ABSTRACT

An eyepiece of the present disclosure includes three or more lenses provided in order from side of an eye point toward side of an image. At least two of the three or more lenses configure a cemented lens. One of the three or more lenses is an aspherical lens. The following conditional expressions are satisfied,

ω′/(tan⁻¹(h/L))≥2.2 (1)

ω′≥0.698 (2)

where “ω′” is a half value (rad) of a maximum field-of-view angle, “h” is a maximum image height, and “L” is a distance from the eye point to the image.

### TECHNICAL FIELD

The present disclosure relates to an eyepiece that enlarges an image (for example, a picture image displayed on an image display device), and to a display apparatus suitable for a head-mounted display, etc. using such an eyepiece.

### BACKGROUND ART

As a display apparatus using an image display device, an electronic viewfinder, an electronic binocular, a head-mounted display (HMD), etc. are known.

### CITATION LIST

### Patent Literature

PTL 1: Japanese Unexamined Patent Application Publication No. 2014-228716

PTL 2: Japanese Unexamined Patent Application Publication No. H10-221614

### SUMMARY OF THE INVENTION

Especially in a head-mounted display, since the head-mounted display is used for a long time while a body of a display apparatus is mounted in front of the eyes, it is required that an eyepiece optical system and the body of the display apparatus be small in size and light in weight. Further, it is also required to allow for viewing of an image at a wide angle of view.

It is desirable to provide an eyepiece capable of enlarging an image at a wide filed-of-view angle and obtaining a performance that allows for suitable use in, for example, a head-mounted display, and to provide a display apparatus mounted with such an eyepiece.

An eyepiece according to one embodiment of the present disclosure includes three or more lenses provided in order from side of an eye point toward side of an image. At least two of the three or more lenses configure a cemented lens. One of the three or more lenses is an aspherical lens. The following conditional expressions are satisfied,

ω′/(tan−1(h/L))≥2.2 (1)

ω′≥0.698 (2)

where “ω′” is a half value (rad) of a maximum field-of-view angle, “h” is a maximum image height, and “L” is a distance from the eye point to the image.

A display apparatus according to one embodiment of the present disclosure is provided with an image display device and an eyepiece that enlarges an image displayed on the image display device. The eyepiece includes the above-described eyepiece according to the embodiment of the present disclosure.

In the eyepiece or the display apparatus according to one embodiment of the present disclosure, three or more lenses are provided, and a configuration of each of the lenses is optimized.

According to the eyepiece or the display apparatus of one embodiment of the present disclosure, since three or more lenses are provided, the cemented lens and the aspherical lens are included, and the configuration of each of the lenses is optimized. It is therefore possible to enlarge an image with a wide field-of-view angle, and to obtain a performance that allows for suitable use in, for example, a head-mounted display.

It is to be noted that the effects described here are not necessarily limiting, and any of effects described in the present disclosure may be provided.

### BRIEF DESCRIPTION OF DRAWINGS

FIG. 1 is an explanatory diagram illustrating a first configuration example of an eyepiece optical system used in, for example, a head-mounted display.

FIG. 2 is an explanatory diagram illustrating a second configuration example of the eyepiece optical system used in, for example, a head-mounted display.

FIG. 3 is a lens cross-sectional view illustrating a first configuration example of an eyepiece according to one embodiment of the present disclosure.

FIG. 4 is a lens cross-sectional view illustrating a second configuration example of the eyepiece according to one embodiment.

FIG. 5 is a lens cross-sectional view illustrating a third configuration example of the eyepiece according to one embodiment.

FIG. 6 is an explanatory diagram related to an image magnification.

FIG. 7 is an explanatory diagram schematically illustrating a state of a light ray passing outermost side of an eyepiece in a case where an image display device is large in size.

FIG. 8 is an explanatory diagram schematically illustrating a state of a light ray passing the outermost side of the eyepiece in a case where the image display device is small in size.

FIG. 9 is an explanatory diagram schematically illustrating a relationship of a size of a filed-of-view angle (FOV) and a size of an eye relief (E.R.) with respect to a height of a light ray passing the outermost side of a first surface of the eyepiece.

FIG. 10 is a lens cross-sectional view of an eyepiece according to Working example 1.

FIG. 11 is an aberration diagram illustrating spherical aberration of the eyepiece according to Working example 1.

FIG. 12 is an aberration diagram illustrating curvature of field and distortion of the eyepiece according to Working example 1.

FIG. 13 is an aberration diagram illustrating chromatic aberration of magnification of the eyepiece according to Working example 1.

FIG. 14 is a lens cross-sectional view of an eyepiece according to Working example 2.

FIG. 15 is an aberration diagram illustrating spherical aberration of the eyepiece according to Working example 2.

FIG. 16 is an aberration diagram illustrating curvature of field and distortion of the eyepiece according to Working example 2.

FIG. 17 is an aberration diagram illustrating chromatic aberration of magnification of the eyepiece according to Working example 2.

FIG. 18 is a lens cross-sectional view of an eyepiece according to Working example 3.

FIG. 19 is an aberration diagram illustrating spherical aberration of the eyepiece according to Working example 3.

FIG. 20 is an aberration diagram illustrating curvature of field and distortion of the eyepiece according to Working example 3.

FIG. 21 is an aberration diagram illustrating chromatic aberration of magnification of the eyepiece according to Working example 3.

FIG. 22 is a lens cross-sectional view of an eyepiece according to Working example 4.

FIG. 23 is an aberration diagram illustrating spherical aberration of the eyepiece according to Working example 4.

FIG. 24 is an aberration diagram illustrating curvature of field and distortion of the eyepiece according to Working example 4.

FIG. 25 is an aberration diagram illustrating chromatic aberration of magnification of the eyepiece according to Working example 4.

FIG. 26 is a lens cross-sectional view of an eyepiece according to Working example 5.

FIG. 27 is an aberration diagram illustrating spherical aberration of the eyepiece according to Working example 5.

FIG. 28 is an aberration diagram illustrating curvature of field and distortion of the eyepiece according to Working example 5.

FIG. 29 is an aberration diagram illustrating chromatic aberration of magnification of the eyepiece according to Working example 5.

FIG. 30 is a lens cross-sectional view of an eyepiece according to Working example 6.

FIG. 31 is an aberration diagram illustrating spherical aberration of the eyepiece according to Working example 6.

FIG. 32 is an aberration diagram illustrating curvature of field and distortion of the eyepiece according to Working example 6.

FIG. 33 is an aberration diagram illustrating chromatic aberration of magnification of the eyepiece according to Working example 6.

FIG. 34 is a lens cross-sectional view of an eyepiece according to Working example 7.

FIG. 35 is an aberration diagram illustrating spherical aberration of the eyepiece according to Working example 7.

FIG. 36 is an aberration diagram illustrating curvature of field and distortion of the eyepiece according to Working example 7.

FIG. 37 is an aberration diagram illustrating chromatic aberration of magnification of the eyepiece according to Working example 7.

FIG. 38 is a lens cross-sectional view of an eyepiece according to Working example 8.

FIG. 39 is an aberration diagram illustrating spherical aberration of the eyepiece according to Working example 8.

FIG. 40 is an aberration diagram illustrating curvature of field and distortion of the eyepiece according to Working example 8.

FIG. 41 is an aberration diagram illustrating chromatic aberration of magnification of the eyepiece according to Working example 8.

FIG. 42 is a lens cross-sectional view of an eyepiece according to Working example 9.

FIG. 43 is an aberration diagram illustrating spherical aberration of the eyepiece according to Working example 9.

FIG. 44 is an aberration diagram illustrating curvature of field and distortion of the eyepiece according to Working example 9.

FIG. 45 is an aberration diagram illustrating chromatic aberration of magnification of the eyepiece according to Working example 9.

FIG. 46 is a lens cross-sectional view of an eyepiece according to Working example 10.

FIG. 47 is an aberration diagram illustrating spherical aberration of the eyepiece according to Working example 10.

FIG. 48 is an aberration diagram illustrating curvature of field and distortion of the eyepiece according to Working example 10.

FIG. 49 is an aberration diagram illustrating chromatic aberration of magnification of the eyepiece according to Working example 10.

FIG. 50 is a lens cross-sectional view of an eyepiece according to Working example 11.

FIG. 51 is an aberration diagram illustrating spherical aberration of the eyepiece according to Working example 11.

FIG. 52 is an aberration diagram illustrating curvature of field and distortion of the eyepiece according to Working example 11.

FIG. 53 is an aberration diagram illustrating chromatic aberration of magnification of the eyepiece according to Working example 11.

FIG. 54 is a lens cross-sectional view of an eyepiece according to Working example 12.

FIG. 55 is an aberration diagram illustrating spherical aberration of the eyepiece according to Working example 12.

FIG. 56 is an aberration diagram illustrating curvature of field and distortion of the eyepiece according to Working example 12.

FIG. 57 is an aberration diagram illustrating chromatic aberration of magnification of the eyepiece according to Working example 12.

FIG. 58 is a lens cross-sectional view of an eyepiece according to Working example 13.

FIG. 59 is an aberration diagram illustrating spherical aberration of the eyepiece according to Working example 13.

FIG. 60 is an aberration diagram illustrating curvature of field and distortion of the eyepiece according to Working example 13.

FIG. 61 is an aberration diagram illustrating chromatic aberration of magnification of the eyepiece according to Working example 13.

FIG. 62 is a lens cross-sectional view of an eyepiece according to Working example 14.

FIG. 63 is an aberration diagram illustrating spherical aberration of the eyepiece according to Working example 14.

FIG. 64 is an aberration diagram illustrating curvature of field and distortion of the eyepiece according to Working example 14.

FIG. 65 is an aberration diagram illustrating chromatic aberration of magnification of the eyepiece according to Working example 14.

FIG. 66 is a lens cross-sectional view of an eyepiece according to Working example 15.

FIG. 67 is an aberration diagram illustrating spherical aberration of the eyepiece according to Working example 15.

FIG. 68 is an aberration diagram illustrating curvature of field and distortion of the eyepiece according to Working example 15.

FIG. 69 is an aberration diagram illustrating chromatic aberration of magnification of the eyepiece according to Working example 15.

FIG. 70 is a lens cross-sectional view of an eyepiece according to Working example 16.

FIG. 71 is an aberration diagram illustrating spherical aberration of the eyepiece according to Working example 16.

FIG. 72 is an aberration diagram illustrating curvature of field and distortion of the eyepiece according to Working example 16.

FIG. 73 is an aberration diagram illustrating chromatic aberration of magnification of the eyepiece according to Working example 16.

FIG. 74 is a lens cross-sectional view of an eyepiece according to Working example 17.

FIG. 75 is an aberration diagram illustrating spherical aberration of the eyepiece according to Working example 17.

FIG. 76 is an aberration diagram illustrating curvature of field and distortion of the eyepiece according to Working example 17.

FIG. 77 is an aberration diagram illustrating chromatic aberration of magnification of the eyepiece according to Working example 17.

FIG. 78 is a lens cross-sectional view of an eyepiece according to Working example 18.

FIG. 79 is an aberration diagram illustrating spherical aberration of the eyepiece according to Working example 18.

FIG. 80 is an aberration diagram illustrating curvature of field and distortion of the eyepiece according to Working example 18.

FIG. 81 is an aberration diagram illustrating chromatic aberration of magnification of the eyepiece according to Working example 18.

FIG. 82 is a lens cross-sectional view of an eyepiece according to Working example 19.

FIG. 83 is an aberration diagram illustrating spherical aberration of the eyepiece according to Working example 19.

FIG. 84 is an aberration diagram illustrating curvature of field and distortion of the eyepiece according to Working example 19.

FIG. 85 is an aberration diagram illustrating chromatic aberration of magnification of the eyepiece according to Working example 19.

FIG. 86 is a lens cross-sectional view of an eyepiece according to Working example 20.

FIG. 87 is an aberration diagram illustrating spherical aberration of the eyepiece according to Working example 20.

FIG. 88 is an aberration diagram illustrating curvature of field and distortion of the eyepiece according to Working example 20.

FIG. 89 is an aberration diagram illustrating chromatic aberration of magnification of the eyepiece according to Working example 20.

FIG. 90 is a lens cross-sectional view of an eyepiece according to Working example 21.

FIG. 91 is an aberration diagram illustrating spherical aberration of the eyepiece according to Working example 21.

FIG. 92 is an aberration diagram illustrating curvature of field and distortion of the eyepiece according to Working example 21.

FIG. 93 is an aberration diagram illustrating chromatic aberration of magnification of the eyepiece according to Working example 21.

FIG. 94 is a lens cross-sectional view of an eyepiece according to Working example 22.

FIG. 95 is an aberration diagram illustrating spherical aberration of the eyepiece according to Working example 22.

FIG. 96 is an aberration diagram illustrating curvature of field and distortion of the eyepiece according to Working example 22.

FIG. 97 is an aberration diagram illustrating chromatic aberration of magnification of the eyepiece according to Working example 22.

FIG. 98 is a lens cross-sectional view of an eyepiece according to Working example 23.

FIG. 99 is an aberration diagram illustrating spherical aberration of the eyepiece according to Working example 23.

FIG. 100 is an aberration diagram illustrating curvature of field and distortion of the eyepiece according to Working example 23.

FIG. 101 is an aberration diagram illustrating chromatic aberration of magnification of the eyepiece according to Working example 23.

FIG. 102 is a lens cross-sectional view of an eyepiece according to Working example 24.

FIG. 103 is an aberration diagram illustrating spherical aberration of the eyepiece according to Working example 24.

FIG. 104 is an aberration diagram illustrating curvature of field and distortion of the eyepiece according to Working example 24.

FIG. 105 is an aberration diagram illustrating chromatic aberration of magnification of the eyepiece according to Working example 24.

FIG. 106 is an external perspective view of a head-mounted display as an example of a display apparatus as seen obliquely from front side.

FIG. 107 is an external perspective view of a head-mounted display as an example of a display apparatus as seen obliquely from rear side.

### MODES FOR CARRYING OUT THE INVENTION

Hereinafter, some embodiments of the present disclosure are described in detail with reference to the drawings. It is to be noted that the description is given in the following order.

0. Comparative Examples

1. Overview of Eyepiece According to One Embodiment (Basic Configuration of Eyepiece)

2. Configuration Examples of Eyepiece According to One Embodiment and Workings and Effects thereof

3. Examples of Application to Display Apparatus

4. Numerical Working Examples of Lenses

5. Other Embodiments

### [0. Comparative Examples]

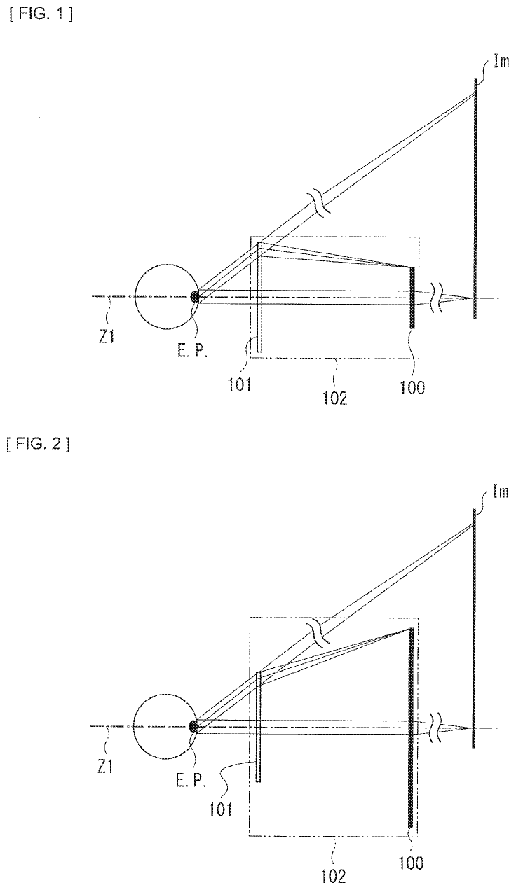

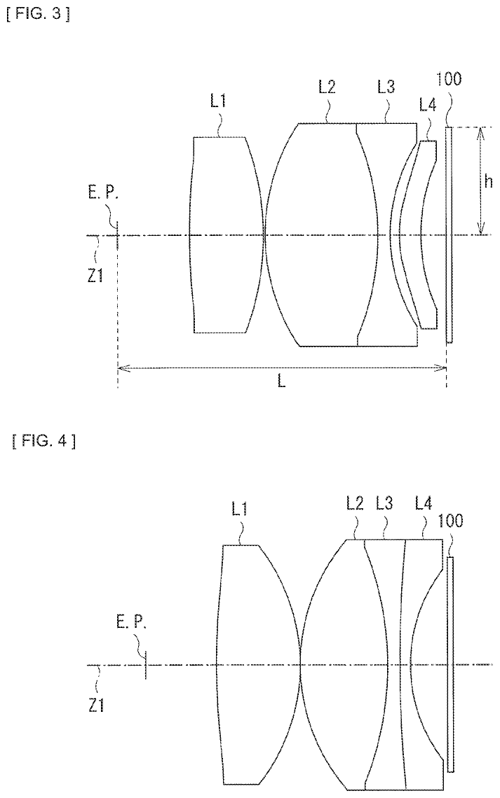

FIG. 1 illustrates a first configuration example of an eyepiece optical system 102 used in, for example, a head-mounted display. FIG. 2 illustrates a second configuration example of the eyepiece optical system 102 used in, for example, a head-mounted display.

The eyepiece optical system 102 includes an eyepiece 101 and an image display device 100 in order from eye point E.P. side along an optical axis Z1.

The image display device 100 is, for example, a display panel such as an LCD (Liquid Crystal Display) or an organic EL display. The eyepiece 101 is used to enlarge and display a picture image displayed on the image display device 100. With the eyepiece 101, a viewer views a virtual image Im that is displayed in an enlarged manner. A seal glass, etc. directed to protecting of the image display device 100 may be disposed on a front surface of the image display device 100. An eye point E.P. corresponds to a position of a pupil of the viewer and also serves as an aperture stop STO.

Here, FIG. 1 illustrates a configuration example in a case where a size of the image display device 100 is smaller than a lens diameter of the eyepiece 101. FIG. 2 illustrates a configuration example in a case where the size of the image display device 100 is greater than the lens diameter of the eyepiece 101.

In a head-mounted display using the coaxial eyepiece optical system 102 and having a great field-of-view angle of 70° or greater, the image display device 100 is often greater in size than the lens diameter of the eyepiece 101. In such a head-mounted display, although it is possible to suppress an image magnification My to be small, a focal length f becomes relatively long. This leads to a concern that a total length of the eyepiece optical system 102 is long. Further, in some cases, a size of the eyepiece optical system 102 is limited not by the size of the eyepiece 101 but by the size of the image display device 100. Such a case is not suitable for reduction in size, which is a problem.

For example, as illustrated in FIG. 1, in a case where the image display device 100 is small in size, the size of the eyepiece optical system 102 as a whole is limited by the size of the eyepiece 101. In contrast, as illustrated in FIG. 2, in a case where the image display device 100 is large in size, the size of the eyepiece optical system 102 as a whole is limited by the size of the image display device 100.

It is to be noted that the image magnification Mv is expressed by Mv=α′/α. As illustrated in FIG. 6, “α” represents a filed-of-view angle in a case where the eyepiece 101 is absent, and “α′” represents the filed-of-view angle in a case where the eyepiece 101 is present (the filed-of-view angle with respect to the virtual image Im). In FIG. 6, “h” is a maximum image height of the picture image to be viewed, and is, for example, a maximum image height of the image displayed on the image display device 100. For example, in a case where the image display device 100 has a rectangular shape, “h” is a half value of a diagonal size of the image display device 100. “f” represents a focal length of the eyepiece 101.

As one technique for improving the above-mentioned problem related to reduction in size, there is a method of shortening the focal length “f” by using a small-sized image display device 101. In an optical system such as an eyepiece of a microscope described in, for example, Patent Literature 2 (Japanese Unexamined Patent Application Publication No. H10-221614), however, it is difficult to secure a wide filed-of-view angle of 70° or greater. Further, in a head-mounted display having a great filed-of-view angle, a pupil position shifts when one views a peripheral region of a picture image (hereinafter, referred to as “eye-shift”). At this time, it is difficult to secure a desired optical characteristic with respect to an estimated amount of eye-shift in the head-mounted display.

Therefore, it is desirable to develop an eyepiece capable of enlarging an image with a wide filed-of-view angle and obtaining a performance that allows for suitable use in, for example, a head-mounted display.

### [1. Overview of Eyepiece According to One Embodiment (Basic Configuration of Eyepiece)]

An eyepiece according to one embodiment of the present disclosure is applicable to, for example, the eyepiece optical system 102 of the head-mounted display, similarly to the comparative examples described above.

The eyepiece according to one embodiment of the present disclosure includes three or more lenses in order from eye point E.P. side toward image side. At least two of the three or more lenses configure a cemented lens. One of the three or more lenses is an aspherical lens. In addition, the following conditional expressions are satisfied,

ω′/(tan⁻¹⁽h/L))≥2.2 (1)

ω′≥0.698 (2)

where “ω” is a half value (rad) of a maximum filed-of-view angle, “h” is a maximum image height (see FIGS. 3 and 6), and “L” is a distance from an eye point E.P. to an image (see FIG. 3).

Satisfying the conditional expression (1) means that the image magnification Mv is 2.2× or greater. Satisfying the conditional expression (2) means that the maximum filed-of-view angle (total filed-of-view angle) is 80° or greater in terms of degrees (°). It is to be noted that the “image” refers to, for example, a picture image displayed on the image display device 100. For example, in the case where the image display device 100 has a rectangular shape, “h” is a half value of the diagonal size of the image display device 100, as described above. “L” corresponds to, for example, the total length of the eyepiece optical system 102 described above (a distance from the eye point E.P. to a display surface of the image display device 100.)

The eyepiece according to one embodiment of the present disclosure is used for a small-sized and high-resolution image display device 100 such as a 4k device having a size of 1.5 inches or smaller, for example. This makes it possible, while securing a filed-of-view angle of 80° or greater, to minimize a decrease in resolution, form a large-sized virtual image, provide a visual picture image with overwhelming reality, and a compact optical system having a short total length. In addition, it is possible to provide an optical system characterized in that a sufficient eye relief E.R. is secured and that it is robust against eye-shift. It is to be noted that the eye relief E.R. refers to a distance between the center of the eye point E.P. and the center of the lens surface, of the eyepiece, closest to the eye point E.P.

### [2. Configuration Examples of Eyepiece According to One Embodiment and Workings and Effects Thereof]

A description is given below of first to third configuration examples satisfying the above-described basic configuration of the eyepiece.

### First Configuration Example

FIG. 3 illustrates the first configuration example of the eyepiece according to one embodiment.

An eyepiece according to the first configuration example has an image magnification My of 2.2× or greater and a filed-of-view angle of 80° or greater, and has a lens configuration including three groups and four lenses.

The eyepiece according to the first configuration example includes a first lens L1, a second lens L2, a third lens L3, and a fourth lens L4 in order from the eye point E.P. side toward the image side.

In the eyepiece according to the first configuration example, it is preferable that the second lens L2 and the third lens L3 configure a cemented lens. Further, it is preferable that the fourth lens L4 be an aspherical lens.

In the eyepiece according to the first configuration example, it is possible to suppress distortion by providing an aspherical lens as the fourth lens L4. At least two lenses may be required to suppress distortion without using an aspherical surface but with using a spherical surface. In addition, the lens is thickened or a lens edge portion is thickened. For this reason, it is difficult to design so as to satisfy a desired optical performance due to the constraint of the total length.

In the eyepiece according to the first configuration example, it is preferable that the second lens L2 have a positive refractive power. Further, it is preferable that the third lens L3 have a negative refractive power. It is possible to achieve maximum chromatic aberration correction by making the second lens L2 have the positive refractive power, making the third lens L3 have the negative refractive power, and making the second lens L2 and the third lens L3 configure the cemented lens.

In the eyepiece according to the first configuration example, it is preferable that each of the first lens L1, the second lens L2, and the third lens L3 have a refractive index of 1.7 or greater with respect to a d-line. By setting the refractive index to be 1.7 or greater, it is possible to suppress the curvature of each of the lens surfaces of the first lens L1, the second lens L2, and the third lens L3 to be small, which allows for reduction in thickness of each lens. Further, in order to suppress the curvature of field, it is necessary to reduce the Petzval sum. In a case where a lens material having a low refractive index is used, however, the thickness of each lens increases, and in addition, occurrence of the curvature of field becomes remarkable, which results in deterioration of an optical performance.

### Second Configuration Example

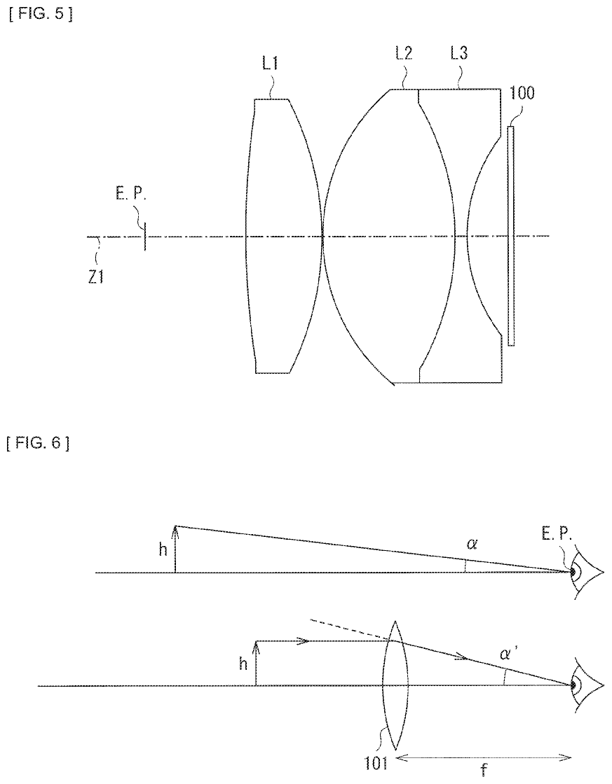

FIG. 4 illustrates the second configuration example of the eyepiece according to one embodiment.

The eyepiece according to the second configuration example has an image magnification Mv of 2.2× or greater and a filed-of-view angle of 80° or greater, and has a lens configuration including two groups and four lenses.

The eyepiece according to the second configuration example includes a first lens L1, a second lens L2, a third lens L3, and a fourth lens L4 in order from the eye point E.P. side toward the image side.

In the eyepiece according to the second configuration example, it is preferable that the second lens L2, the third lens L3, and the fourth lens L4 configure a cemented lens. Further, it is preferable that the first lens L1 be an aspherical lens.

In the eyepiece according to one embodiment, it is desirable that the three colors of R (red), G (green), and B (blue) be achromatic ideally. In the eyepiece according to the second configuration example, the three lenses of the second lens L2, the third lens L3, and the fourth lens L4 are joined together. This makes it easier to perform achromatization of the three colors. In the eyepiece according to one embodiment, occurrence of chromatic aberration of magnification may be remarkable since the filed-of-view angle of the eyepiece is great and the focal length of the eyepiece is short. In order to solve this, it is greatly effective to join three lenses.

In the eyepiece according to the second configuration example, it is preferable that the second lens L2 have a positive refractive power. Further, it is preferable that the third lens L3 have a negative refractive power. Further, it is preferable that the fourth lens L4 have a positive or negative refractive power. This makes it easier to correct chromatic aberration.

In the eyepiece according to the second configuration example, it is preferable that each of the first lens L1, the second lens L2, the third lens L3, and the fourth lens L4 has a refractive index of 1.7 or greater with respect to the d-line. By setting the refractive index to be 1.7 or greater, it is possible to suppress the curvature of each of the lens surfaces of the first lens L1, the second lens L2, the third lens L3, and the fourth lens L4 to be small, which allows for reduction in thickness of each lens. Further, in order to suppress the curvature of field, it is necessary to reduce the Petzval sum. In a case where a lens material having a low refractive index is used, however, the thickness of each lens increases, and in addition, occurrence of the curvature of field becomes remarkable, which results in deterioration of an optical performance.

### Third Configuration Example

FIG. 5 illustrates the third configuration example of the eyepiece according to one embodiment.

The eyepiece according to the third configuration example has an image magnification Mv of 2.2× or greater and a filed-of-view angle of 80° or greater, and has a lens configuration including two groups and three lenses.

The eyepiece according to the third configuration example includes a first lens L1, a second lens L2, and a third lens L3 in order from the eye point E.P. side toward the image side.

In the eyepiece according to the third configuration example, it is preferable that the second lens L2 and the third lens L3 configure a cemented lens. Further, it is preferable that the first lens L1 be an aspherical lens.

Also in a configuration in which two lenses are joined, it is possible to favorably correct the chromatic aberration of magnification, as with the configuration in which three lenses are joined. In the configuration in which two lenses are joined, a performance of chromatic aberration is compromised as compared with the configuration in which three lenses are joined; however, it is possible to achieve reduction in total length and reduction in weight.

In the eyepiece according to the third configuration example, it is preferable that the second lens L2 have a positive refractive power. Further, it is preferable that the third lens L3 have a negative refractive power. It is possible to achieve maximum chromatic aberration correction by making the second lens L2 have the positive refractive power, making the third lens L3 have the negative refractive power, and making the second lens L2 and the third lens L3 to configure the cemented lens.

### Preferable Configuration Common to First to Third Configuration Examples

In the eyepiece according to one embodiment, it is preferable that a lens surface closest to the eye point E.P. of the three or more lenses (a lens surface, of the first lens L1, on the eye point E.P. side) have a convex shape or a planar shape. This makes it possible to secure a longer eye relief E.R., which achieves an easier-to-view structure. For example, in a concave lens having a great power, even if a certain degree of eye relief E.R. is secured, an edge portion of the lens interferes with the eye, making it more difficult to view therewith.

It is preferable that the eyepiece according to one embodiment further satisfy the following conditional expression,

0.78<f/(L31 ER)<0.97 (3)

where “f” is an effective focal distance, “ER” is an eye relief, and “L” is a distance from the eye point E.P. to the image (see FIG. 3).

The conditional expression (3) represents that the effective focal length “f” is smaller than (L−ER). If the conditional expression (3) is not satisfied, it is difficult to obtain a favorable image formation characteristic. By satisfying the conditional expression (3), it is possible to obtain a favorable image formation characteristic while reducing the size of the optical system. In a region close to the upper limit of the conditional expression (3), the filed-of-view angle is great. It is therefore necessary to reduce the effective focal length f; however, it is possible to obtain a favorable image formation performance by increasing the total length of the eyepiece to the maximum within the range of the conditional expression (3). In a region greater than 0.97, it is difficult to obtain a favorable resolution. One reason for this is that correction of behavior of a peripheral light ray at a great filed-of-view angle cannot be performed sufficiently and cannot be achieved even if the total length is increased. As a result, the conditional expression (3) is not satisfied. In this case, in particular, a resolution of a peripheral portion, curvature of field of the peripheral portion, and a distortion characteristic of the peripheral portion are deteriorated. In a region close to the lower limit of the conditional expression (3), the minimum total length is so defined that a favorable resolution characteristic is obtainable particularly in a case where the filed-of-view angle is small.

It is preferable that the eyepiece according to one embodiment further satisfy the following conditional expression,

0.764<t′/L′ (4)

where “t” is a sum of center thicknesses of respective three or more lenses, and “L” is a distance from the lens surface closest to the eye point E.P. in the three or more lenses to the image.

By satisfying the conditional expression (4), it is possible to secure a sufficient lens thickness, and achieve a robust characteristic against the eye-shift.

### Effect of the Invention

According to the eyepiece according to one embodiment of the present disclosure, three or more lenses are provided, a cemented lens and an aspherical lens are included, and the configuration of each of the lenses is optimized. This allows for enlarging of an image with a great filed-of-view angle. It is therefore possible to obtain a performance that allows for favorable use in, for example, a head-mounted display.

By applying the eyepiece according to one embodiment to a head-mounted display, it is possible to provide high-definition beauty of a picture image at a great filed-of-view angle. According to the eyepiece of one embodiment, it is possible to reduce the total length (the distance L from the eye point E.P. to the image). Further, it is possible to suppress the size of the optical system in a case of being applied to the eyepiece optical system 102 (the maximum light ray height) to be small. Further, it is possible to achieve the eyepiece optical system 102 that is robust against the eye-shift. Further, it is possible to achieve the eyepiece optical system 102 in which axial chromatic aberration and the magnification chromatic aberration are corrected favorably.

It is to be noted that the effects described in this specification are merely illustrative and not limiting, and other effects may be provided.

### [3. Application Examples to Display Apparatus]

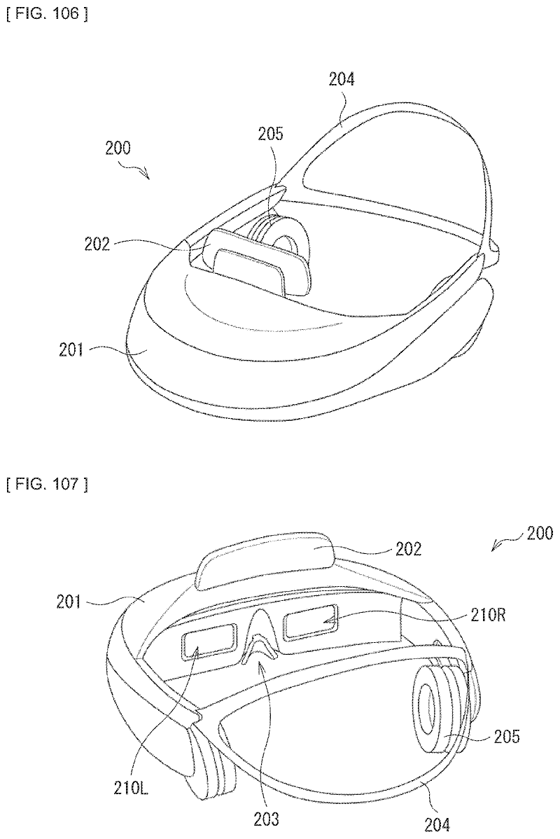

FIGS. 106 and 107 each illustrate a configuration example of a head-mounted display 200 as an example of a display apparatus to which the eyepiece according to one embodiment of the present disclosure is applied. The head-mounted display 200 includes a main body part 201, a forehead rest part 202, a nose rest part 203, a headband 204, and headphones 205. The forehead rest part 202 is provided at an upper-middle portion of the main body part 201. The nose rest part 203 is provided at a lower-middle portion of the main body part 201.

When a user wears the head-mounted display 200 on his/her head, the forehead rest part 202 comes in contact with the forehead of the user and the nose rest part 203 comes in contact with his/her nose. In addition, the headband 204 comes in contact with the back of his/her head. As a result, in the head-mounted display 200, a load of the apparatus is distributed over the entire head. This makes it possible for the user to wear the head-mounted display 200 while the load on the user is reduced.

The headphones 205 are provided for a left ear and a right ear. This makes it possible to independently provide a sound to the left ear and the right ear.

The main body part 201 is provided with a circuit board, an optical system, etc. that are directed to displaying of a picture image and are built in the main body part 201. As illustrated in FIG. 107, the main body part 201 is provided with a left-eye display unit 210L and a right-eye display unit 210R. This makes it possible to provide picture images to the left eye and the right eye independently. The left-eye display unit 210L is provided with an image display device 100 for the left eye and an eyepiece optical system for the left eye that enlarges a picture image displayed on the image display device 100 for the left eye. The right-eye display unit 210R is provided with an image display device 100 for the right eye and an eyepiece optical system for the right eye that enlarges a picture image displayed on the image display device 100 for the righteye. The eyepiece according to one embodiment of the present disclosure is applicable as each of the eyepiece optical system for the left eye and the eyepiece optical system for the right eye described above.

It is to be noted the image display device 100 receives picture image data from an unillustrated image reproducing apparatus. It is also possible to perform three-dimensional display by supplying three-dimensional picture image data from the image reproducing apparatus and displaying picture images having parallax by the left-eye display unit 210L and the right-eye display unit 210R.

It is to be noted that, although an example in which the display apparatus is applied to the head-mounted display 200 is described here, an application range of the display apparatus is not limited to the head-mounted display 200. The display apparatus may be applied to, for example, electronic binoculars, an electronic viewfinder of a camera, etc.

Further, the eyepiece according to one embodiment of the present disclosure is applicable not only to the use of enlarging a picture image displayed on the image display device 100, but also to an observation apparatus that enlarges an optical image formed by an objective lens.

### WORKING EXAMPLES

### Overview of Working Examples

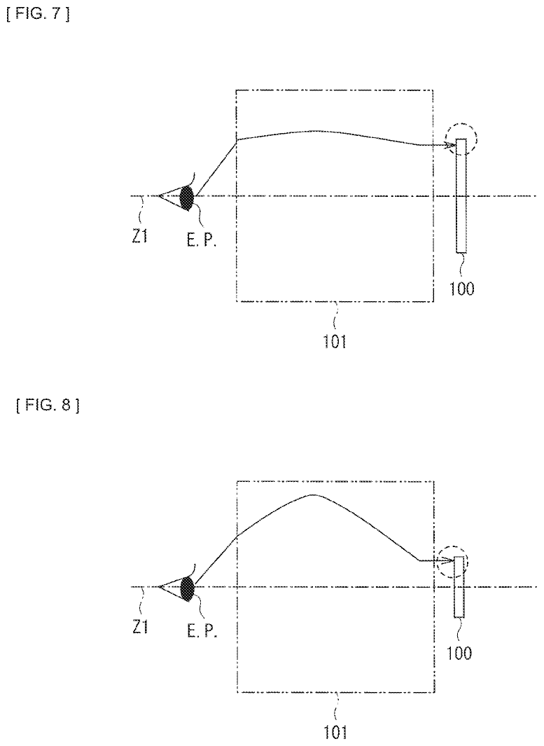

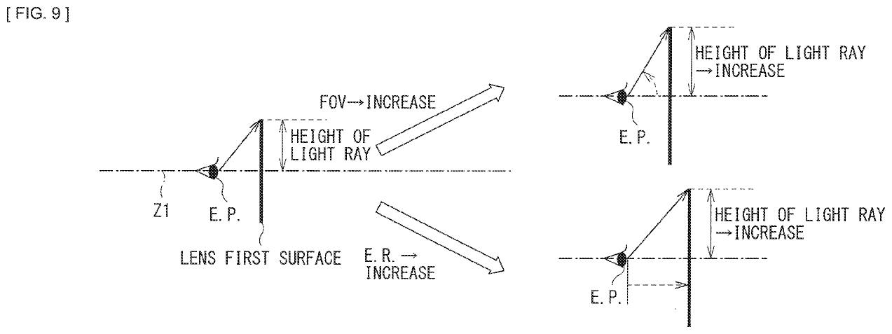

FIG. 7 schematically illustrates a state of a light ray passing the outermost side of the eyepiece 101 in a case where the image display device 100 is large in size. FIG. 8 schematically illustrates a state of a light ray passing the outermost side of the eyepiece 101 in a case where the image display device 100 is small in size. FIG. 9 schematically illustrates a relationship of the height of the light ray passing the outermost side of the first surface of the eyepiece 101 with respect to the size of the field-of-view angle (FOV) and the size of the eye relief (E.R.).

FIGS. 7 and 8 each schematically illustrate behavior of the light ray passing the outermost side of the eyepiece 101. Specification of the eyepiece 101 illustrated in FIG. 7 and the eyepiece 101 illustrated in FIG. 8 are the same in the field-of-view angle and are different in the size of the image display device 100 (panel size). As illustrated in FIG. 8, when the image display device 100 is small in size, it is necessary to greatly bend the light ray in order to form an image of the light ray at a low position. This causes a greater amount of aberration to occur.

Further, as illustrated in FIG. 9, the height of the light ray passing the outermost side of the first surface of the eyepiece 101 is increased as a result of the size of the field-of-view angle (FOV) and the size of the eye relief (E.R.). This causes a greater amount of aberration to occur. As described above, the size of the image display device 100, the field-of-view angle of the image display device 100, and the eye relief E.R. of the image display device 100 have a trade-off relationship with the image formation performance.

In consideration of such a characteristic, the following working examples are described with design examples having respective specifications that are different from each other in the field-of-view angle, the eye relief E.R., and the size (panel size) of the image display device 100 as described in Table 1. Here, Working examples 1 to 8 each correspond to the eyepiece of the first configuration example described above (FIG. 3). Working examples 9 to 16 each correspond to the eyepiece of the second configuration example described above (FIG. 4). Working examples 17 to 24 each correspond to the eyepiece of the third configuration example described above (FIG. 5).

TABLE 1

| | Working | Working | Working | Working | Working | Working | Working | Working |
|---|---|---|---|---|---|---|---|---|
| | example | example | example | example | example | example | example | example |
| | 1 | 2 | 3 | 4 | 5 | 6 | 7 | 8 |
| Lens | 3 groups | 3 groups | 3 groups | 3 groups | 3 groups | 3 groups | 3 groups | 3 groups |
| configuration | 4 lenses | 4 lenses | 4 lenses | 4 lenses | 4 lenses | 4 lenses | 4 lenses | 4 lenses |
| Field-of-view | 100 | 90 | 100 | 90 | 90 | 80 | 90 | 80 |
| angle [°] | | | | | | | | |
| Eye relief [mm] | 15 | 15 | 11 | 11 | 15 | 15 | 11 | 11 |
| Panel size [mm] | 32.16 | 32.16 | 32.16 | 32.16 | 23.62 | 23.62 | 23.62 | 23.62 |
| | Working | Working | Working | Working | Working | Working | Working | Working |
| | example | example | example | example | example | example | example | example |
| | 9 | 10 | 11 | 12 | 13 | 14 | 15 | 16 |
| Lens | 2 groups | 2 groups | 2 groups | 2 groups | 2 groups | 2 groups | 2 groups | 2 groups |
| configuration | 4 lenses | 4 lenses | 4 lenses | 4 lenses | 4 lenses | 4 lenses | 4 lenses | 4 lenses |
| Field-of-view | 100 | 90 | 100 | 90 | 100 | 90 | 100 | 90 |
| angle [°] | | | | | | | | |
| Eye relief [mm] | 15 | 15 | 11 | 11 | 15 | 15 | 11 | 11 |
| Panel size [mm] | 32.16 | 32.16 | 32.16 | 32.16 | 23.62 | 23.62 | 23.62 | 23.62 |
| | Working | Working | Working | Working | Working | Working | Working | Working |
| | example | example | example | example | example | example | example | example |
| | 17 | 18 | 19 | 20 | 21 | 22 | 23 | 24 |
| Lens | 2 groups | 2 groups | 2 groups | 2 groups | 2 groups | 2 groups | 2 groups | 2 groups |
| configuration | 3 lenses | 3 lenses | 3 lenses | 3 lenses | 3 lenses | 3 lenses | 3 lenses | 3 lenses |
| Field-of-view | 100 | 90 | 100 | 90 | 100 | 90 | 100 | 90 |
| angle [°] | | | | | | | | |
| Eye relief [mm] | 15 | 15 | 11 | 11 | 15 | 15 | 11 | 11 |
| Panel size [mm] | 32.16 | 32.16 | 32.16 | 32.16 | 23.62 | 23.62 | 23.62 | 23.62 |

It is to be noted that “ω′” in the above-described conditional expressions (1) and (2) corresponds to a half value of the maximum field-of-view angle (total field-of-view angle) in terms of degrees (°). The above-described conditional expression (2) corresponds to that “2ω′” is 80° or greater. As described in Table 1, the field-of-view angle of each of the working examples is 80° or greater, and satisfies the conditional expression (2).

### [4. Numerical Working Examples of Lenses]

Specific lens data are described below of the eyepiece according to each of the working examples described in Table 1 mentioned above.

It is to be noted that meanings, etc. of symbols used in the following tables and descriptions are as follows. “Si” indicates the number of the i-th plane, which is numbered with a sign so as to sequentially increase toward the image side, with the eye point E.P. as the first. “Ri” indicates a radius of curvature (mm) of a paraxial axis of the i-th plane. “Di” indicates a distance (mm), on an optical axis, from the i-th plane to the (i+1)-th plane. “Ndi” indicates a value of a refractive index at the d-line (wavelength of 587.6 nm) of a material (medium) of an optical element having the i-th surface. “vdi” indicates a value of Abbe's number at the d-line of the material of the optical element having the i-th plane. A plane having a radius of curvature of “∞” indicates a plane or a diaphragm plane (aperture stop STO).

The eyepiece according to each of the working examples includes an aspherical lens. An aspherical surface shape is defined by the following expression of aspherical surface. It is to be noted that, in the following tables describing aspherical coefficients, “E-n” represents an exponential expression with a base of 10, that is, “minus n-th power of 10”. To give an example, “0.12345E-05” represents “0.12345×(minus-5th power of 10)”.

### Expression of Aspherical Surface

Z=(Y²/R)/[1+{1−(1+K)(Y²/R²)}^{1/2}]+ΣAi•Yi

where “Z” is a depth of an aspherical surface, “Y” is a height from an optical axis, “R” is a paraxial radius of curvature, “K” is a cone constant, and “Ai” is an aspheric coefficient of i-th order (“i” is an integer of 3 or greater).

### Working Example 1

Table 2 describes basic lens data of an eyepiece according to Working example 1. Further, Table 3 describes data of aspherical surfaces.

TABLE 2
Working example 1/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 15.000 | — | — |
| 2 | 1130.707 | 11.987 | 1.883 | 40.8 |
| 3 | −37.195 | 0.250 | — | — |
| 4 | 32.364 | 26.471 | 1.883 | 40.8 |
| 5 | −38.724 | 1.500 | 1.959 | 17.5 |
| 6 | 286.536 | 0.250 | — | — |
| 7 | 39.934 | 4.274 | 1.531 | 56.0 |
| 8 | 67.187 | 0.600 | — | — |
| 9 | ∞ | 0.700 | 1.517 | 64.2 |

TABLE 3
Working example1/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | — | — | — | — | — | — | — |
| 3 | — | — | — | — | — | — | — |
| 4 | — | — | — | — | — | — | — |
| 5 | — | — | — | — | — | — | — |
| 6 | — | — | — | — | — | — | — |
| 7 | −2.662E+02 | −9.050E−06 | 3.915E−07 | −1.714E−08 | 1.823E−10 | −8.070E−13 | 1.633E−15 |
| 8 | 1.043E+01 | −3.717E−04 | 5.408E−06 | −3.470E−08 | 9.231E−11 | −2.330E−14 | −3.080E−16 |
| 9 | — | — | — | — | — | — | — |

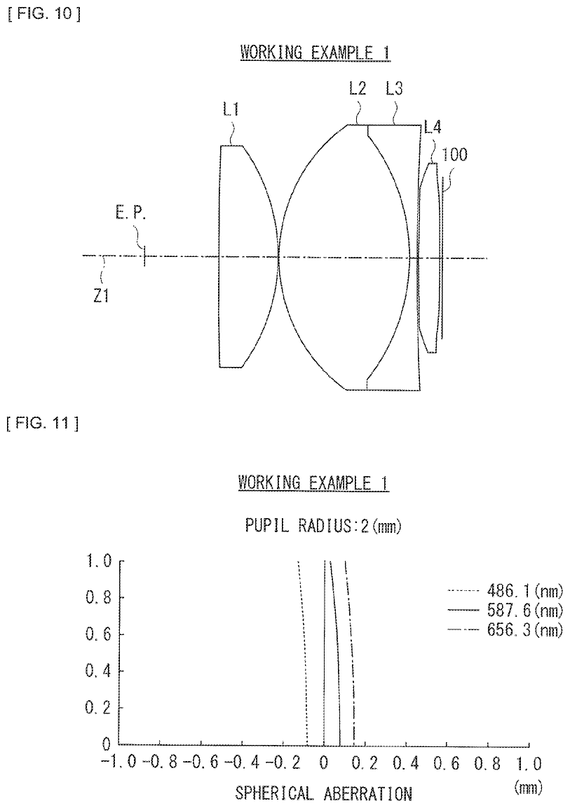

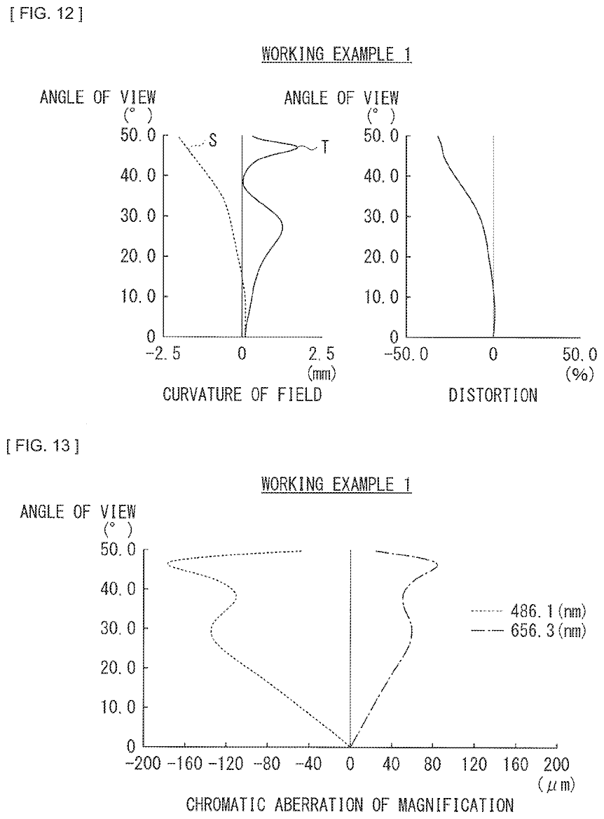

FIG. 10 illustrates a lens cross-section of the eyepiece according to Working example 1. FIGS. 11 to 13 illustrate various aberrations of the eyepiece according to Working example 1. Each aberration is obtained by tracing a light ray from the eye point E.P. side. In particular, FIG. 11 illustrates spherical aberration. FIG. 12 illustrates astigmatism (curvature of field) and distortion. FIG. 13 illustrates chromatic aberration of magnification. The spherical aberration diagram illustrates values for a wavelength of 486.1 (nm), a wavelength of 587.6 (nm), and a wavelength of 656.3 (nm). The astigmatism diagram and the distortion diagram illustrate values for the wavelength of 587.6 (nm). In the astigmatism diagram, “S” indicates a value on a sagittal image plane, and “T” indicates a value on a tangential image plane. The magnification chromatic aberration diagram illustrates values for a wavelength of 486.1 (nm) and a wavelength of 656.3 (nm) with a wavelength of 587.6 (nm) as a reference wavelength. The above is similarly applicable to the aberration diagrams of other working examples described below.

As can be appreciated from the respective aberration diagrams, it is apparent that Working example 1 has a favorable optical performance.

### Working Example 2

Table 4 describes basic lens data of an eyepiece according to Working example 2. Further, Table 5 describes data of aspherical surfaces.

TABLE 4
Working example 2/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 15.000 | — | — |
| 2 | 158.218 | 10.786 | 1.883 | 40.8 |
| 3 | −41.589 | 0.250 | — | — |
| 4 | 31.092 | 20.445 | 1.883 | 40.8 |
| 5 | −36.545 | 1.500 | 1.959 | 17.5 |
| 6 | 35.133 | 5.173 | — | — |
| 7 | −10.866 | 2.282 | 1.531 | 56.0 |
| 8 | −17.426 | 0.600 | — | — |
| 9 | ∞ | 0.700 | 1.517 | 64.2 |

TABLE 5
Working example 2/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | — | — | — | — | — | — | — |
| 3 | — | — | — | — | — | — | — |
| 4 | — | — | — | — | — | — | — |
| 5 | — | — | — | — | — | — | — |
| 6 | — | — | — | — | — | — | — |
| 7 | −2.677E+00 | 2.020E−04 | −9.738E−07 | 3.280E−09 | −4.015E−12 | — | — |
| 8 | −5.373E−01 | 3.273E−04 | −6.879E−07 | −2.327E−09 | 7.133E−12 | — | — |
| 9 | — | — | — | — | — | — | — |

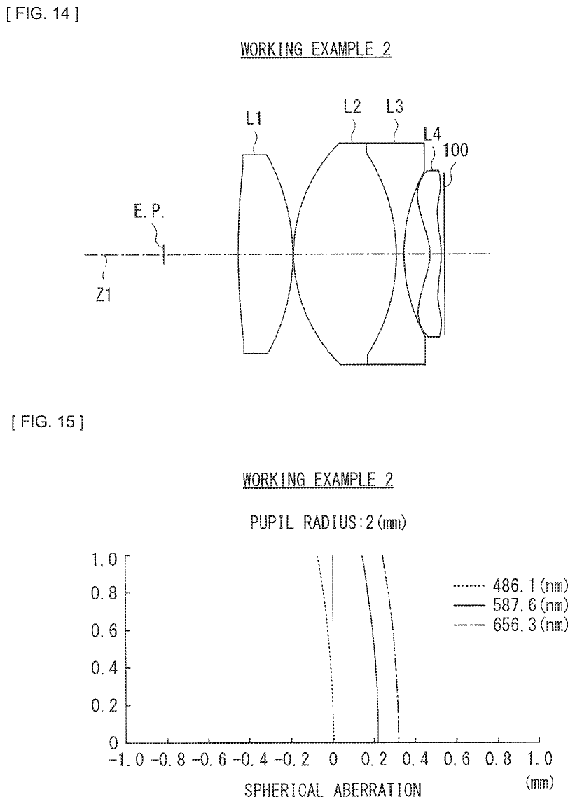

FIG. 14 illustrates a lens cross-section of the eyepiece according to Working example 2.

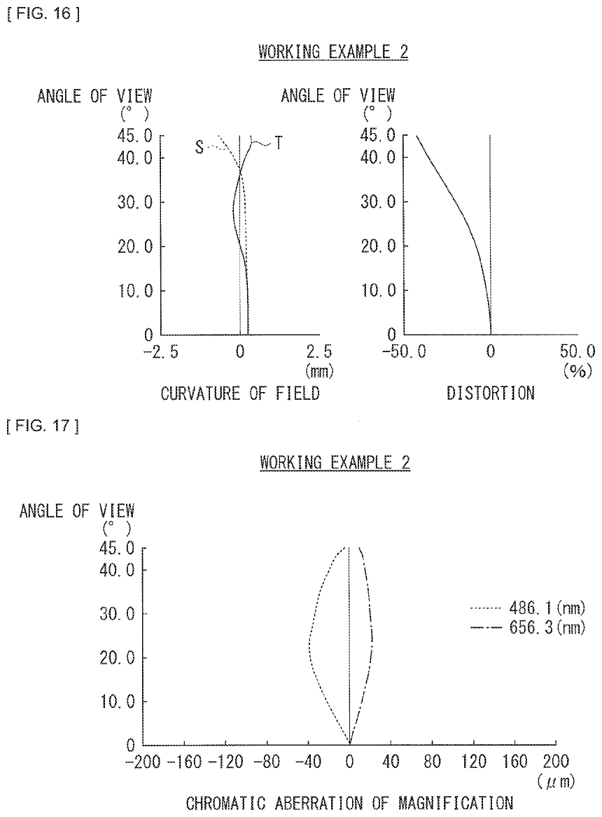

FIGS. 15 to 17 illustrate various aberrations of the eyepiece according to Working example 2.

As can be appreciated from the respective aberration diagrams, it is apparent that the eyepiece according to Working example 2 has a favorable optical performance.

### Working Example 3

Table 6 describes basic lens data of an eyepiece according to Working example 3. Further, Table 7 describes data of aspherical surfaces.

TABLE 6
Working example 3/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 11.000 | — | — |
| 2 | 232.070 | 10.094 | 1.883 | 40.8 |
| 3 | −34.200 | 0.248 | — | — |
| 4 | 30.398 | 17.923 | 1.883 | 40.8 |
| 5 | −40.522 | 2.000 | 1.959 | 17.5 |
| 6 | 43.903 | 2.830 | — | — |
| 7 | −107.538 | 1.500 | 1.531 | 56.0 |
| 8 | 25.551 | 3.279 | — | — |
| 9 | ∞ | 0.700 | 1.517 | 64.2 |

TABLE 7
Working example 3/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | — | — | — | — | — | — | — |
| 3 | — | — | — | — | — | — | — |
| 4 | — | — | — | — | — | — | — |
| 5 | — | — | — | — | — | — | — |
| 6 | — | — | — | — | — | — | — |
| 7 | 3.809E+01 | −6.931E−05 | 8.512E−07 | −2.706E−09 | 4.175E−12 | — | — |
| 8 | −8.140E+00 | −3.540E−06 | −1.034E−08 | −3.190E−10 | 5.010E−13 | — | — |
| 9 | — | — | — | — | — | — | — |

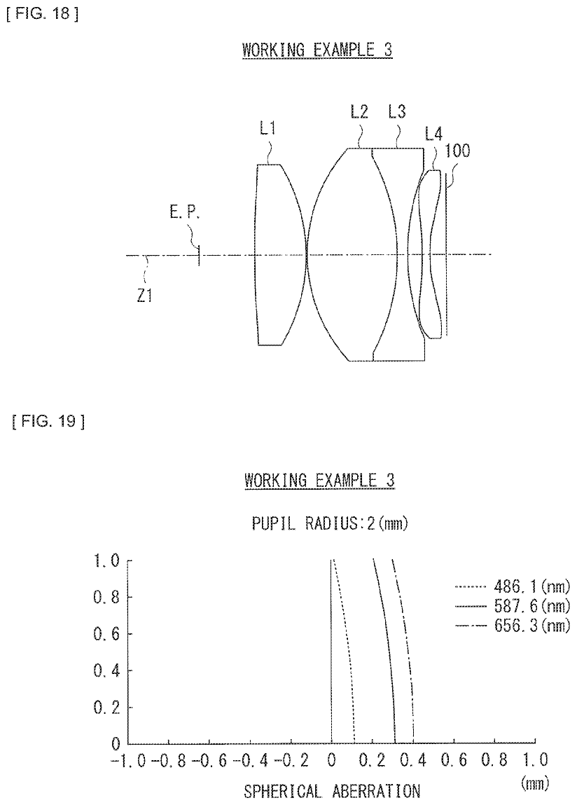

FIG. 18 illustrates a lens cross-section of the eyepiece according to Working example 3.

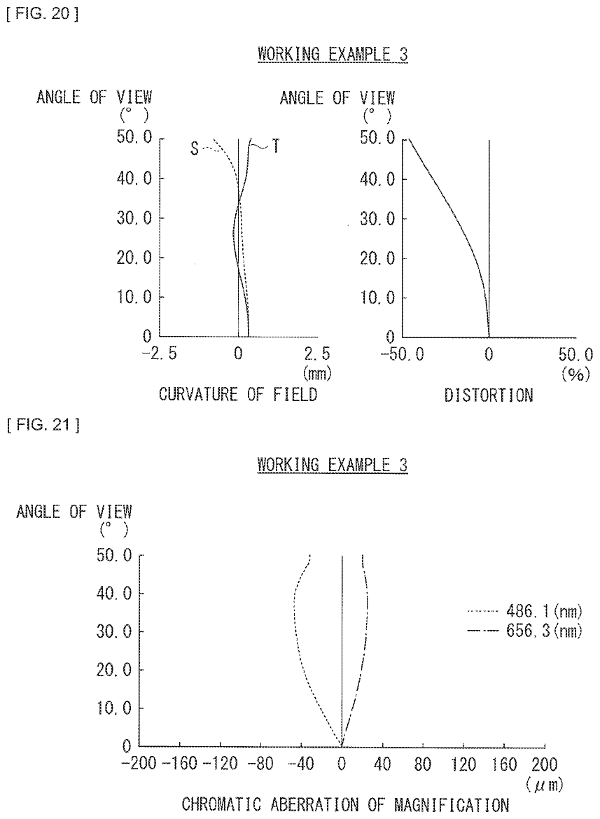

FIGS. 19 to 21 illustrate various aberrations of the eyepiece according to Working example 3.

As can be appreciated from the respective aberration diagrams, it is apparent that the eyepiece according to Working example 3 has a favorable optical performance.

### Working Example 4

Table 8 describes basic lens data of an eyepiece according to Working example 4. Further, Table 9 describes data of aspherical surfaces.

TABLE 8
Working example 4/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 11.000 | — | — |
| 2 | 121.346 | 9.530 | 1.755 | 52.3 |
| 3 | −33.115 | 0.250 | — | — |
| 4 | 30.178 | 15.149 | 1.883 | 40.8 |
| 5 | −39.422 | 5.249 | 1.959 | 17.5 |
| 6 | 33.752 | 5.410 | — | — |
| 7 | −47.668 | 1.500 | 1.531 | 56.0 |
| 8 | −37.277 | 0.600 | — | — |
| 9 | ∞ | 0.700 | 1.517 | 64.2 |

TABLE 9
Working example 4/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | — | — | — | — | — | — | — |
| 3 | — | — | — | — | — | — | — |
| 4 | — | — | — | — | — | — | — |
| 5 | — | — | — | — | — | — | — |
| 6 | — | — | — | — | — | — | — |
| 7 | 3.359E+00 | −8.082E−05 | 5.985E−07 | −6.389E−10 | — | — | — |
| 8 | −6.177E+02 | 1.153E−05 | −1.871E−07 | 6.358E−10 | — | — | — |
| 9 | — | — | — | — | — | — | — |

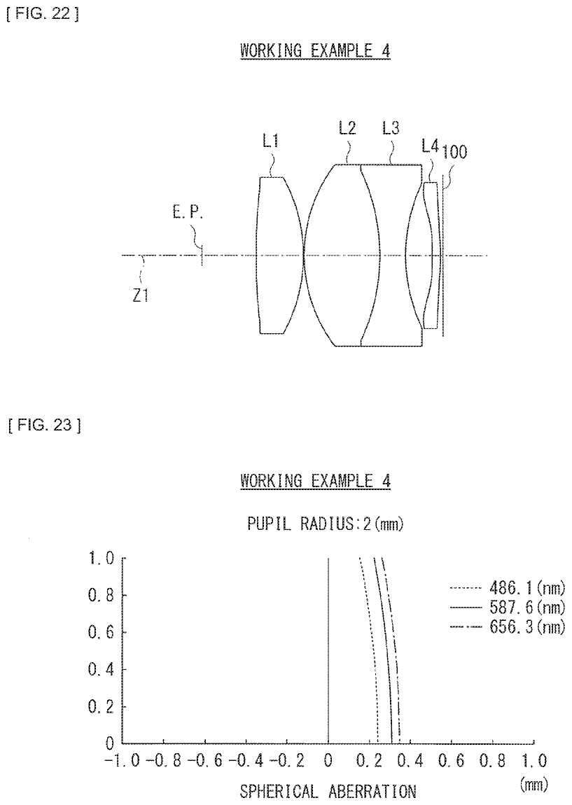

FIG. 22 illustrates a lens cross-section of the eyepiece according to Working example 4.

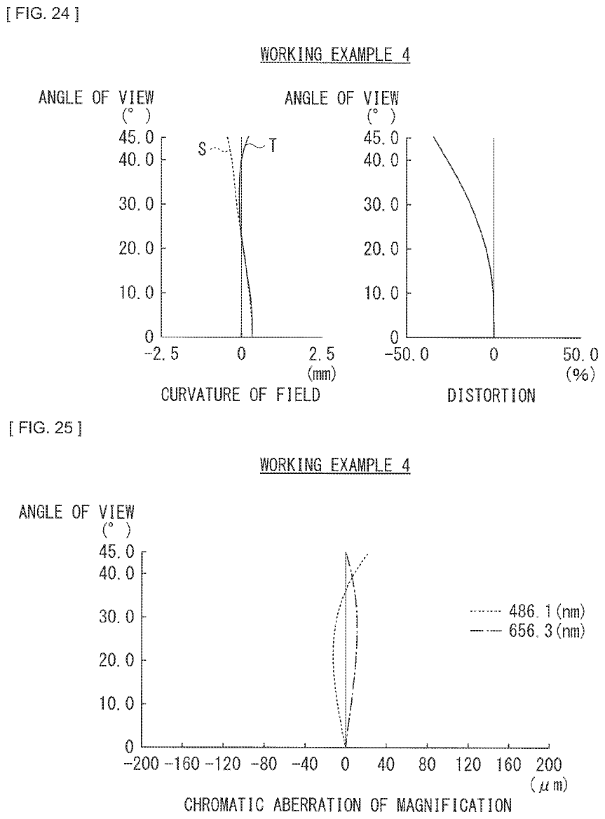

FIGS. 23 to 25 illustrate various aberrations of the eyepiece according to Working example 4.

As can be appreciated from the respective aberration diagrams, it is apparent that the eyepiece according to Working example 4 has a favorable optical performance.

### Working Example 5

Table 10 describes basic lens data of an eyepiece according to Working example 5. Further, Table 11 describes data of aspherical surfaces.

TABLE 10
Working example 5/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 15.000 | — | — |
| 2 | 379.648 | 10.258 | 1.883 | 40.8 |
| 3 | −34.292 | 0.250 | — | — |
| 4 | 25.453 | 19.065 | 1.883 | 40.8 |
| 5 | −55.345 | 2.995 | 1.959 | 17.5 |
| 6 | 67.239 | 1.000 | — | — |
| 7 | −45.243 | 3.254 | 1.531 | 56.0 |
| 8 | 16.035 | 1.000 | — | — |
| 9 | ∞ | 0.700 | 1.517 | 64.2 |

TABLE 11
Working example 5/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | — | — | — | — | — | — | — |
| 3 | — | — | — | — | — | — | — |
| 4 | — | — | — | — | — | — | — |
| 5 | — | — | — | — | — | — | — |
| 6 | — | — | — | — | — | — | — |
| 7 | 0 | 3.338E−04 | −5.720E−06 | 4.818E−08 | −1.706E−10 | 2.097E−13 | — |
| 8 | 0 | −8.514E−04 | 8.184E−06 | −4.045E−08 | 1.013E−10 | −1.195E−13 | — |
| 9 | — | — | — | — | — | — | — |

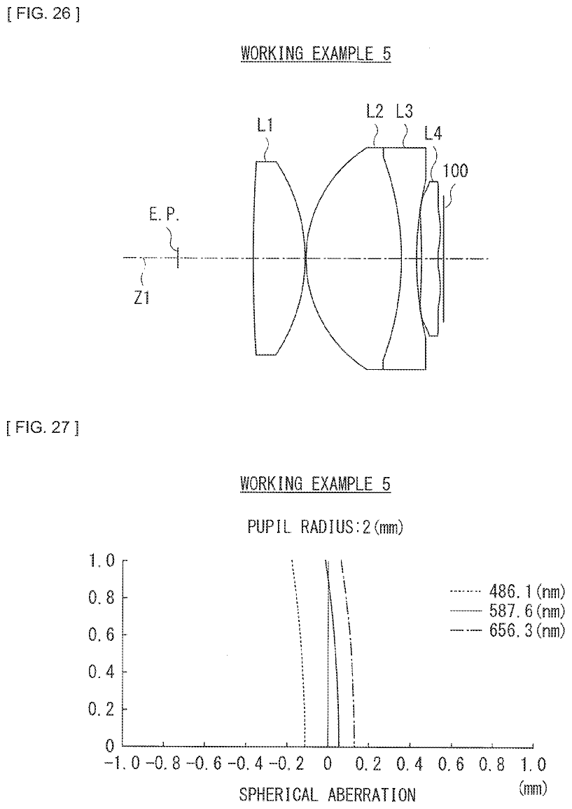

FIG. 26 illustrates a lens cross-section of the eyepiece according to Working example 5.

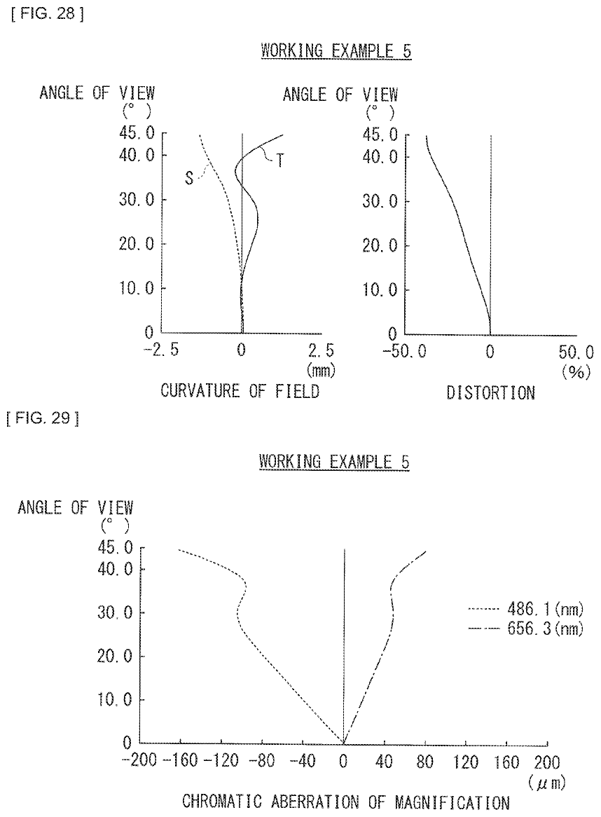

FIGS. 27 to 29 illustrate various aberrations of the eyepiece according to Working example 5.

As can be appreciated from the respective aberration diagrams, it is apparent that the eyepiece according to Working example 5 has a favorable optical performance.

### Working Example 6

Table 12 describes basic lens data of an eyepiece according to Working example 6. Further, Table 13 describes data of aspherical surfaces.

TABLE 12
Working example 6/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 15.000 | — | — |
| 2 | 119.348 | 9.326 | 1.816 | 46.6 |
| 3 | −37.286 | 0.250 | — | — |
| 4 | 25.733 | 16.185 | 1.883 | 40.8 |
| 5 | −43.042 | 3.000 | 1.959 | 17.5 |
| 6 | 26.741 | 0.479 | — | — |
| 7 | 36.199 | 4.818 | 1.531 | 56.0 |
| 8 | ∞ | 2.197 | — | — |
| 9 | ∞ | 0.700 | 1.517 | 64.2 |

TABLE 13
Working example 6/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | — | — | — | — | — | — | — |
| 3 | — | — | — | — | — | — | — |
| 4 | — | — | — | — | — | — | — |
| 5 | — | — | — | — | — | — | — |
| 6 | — | — | — | — | — | — | — |
| 7 | −1.310E+00 | 1.109E−04 | −2.386E−06 | 2.079E−08 | −5.288E−11 | — | — |
| 8 | 0 | 4.249E−04 | −3.149E−06 | 9.587E−10 | 2.398E−11 | — | — |
| 9 | — | — | — | — | — | — | — |

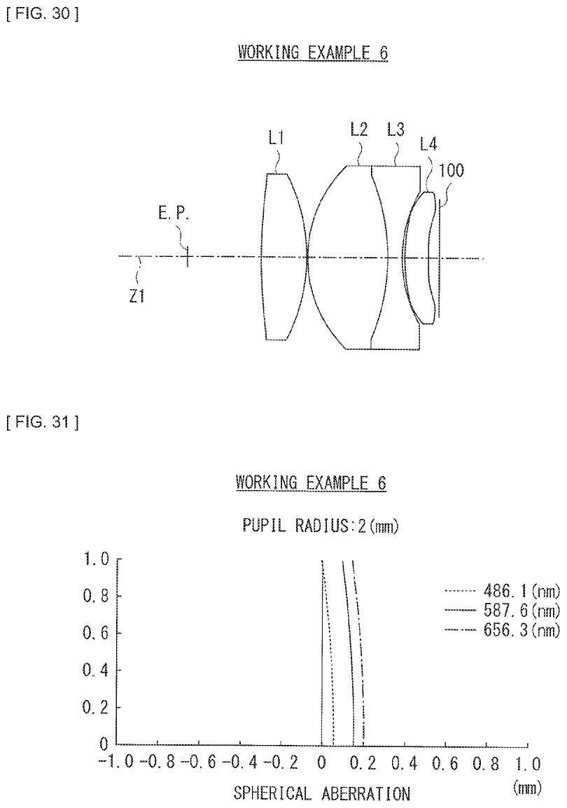

FIG. 30 illustrates a lens cross-section of the eyepiece according to Working example 6.

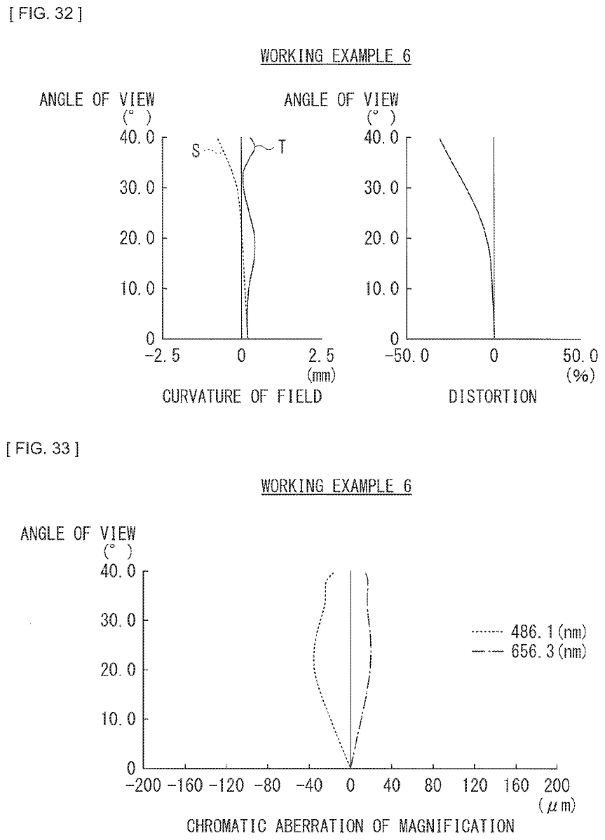

FIGS. 31 to 33 illustrate various aberrations of the eyepiece according to Working example 6.

As can be appreciated from the respective aberration diagrams, it is apparent that the eyepiece according to Working example 6 has a favorable optical performance.

### Working Example 7

Table 14 describes basic lens data of an eyepiece according to Working example 7. Further, Table 15 describes data of aspherical surfaces.

TABLE 14
Working example 7/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 11.000 | — | — |
| 2 | 158.699 | 8.465 | 1.883 | 40.8 |
| 3 | −32.135 | 0.250 | — | — |
| 4 | 23.839 | 14.326 | 1.883 | 40.8 |
| 5 | −55.524 | 2.997 | 1.959 | 17.5 |
| 6 | 28.069 | 1.778 | — | — |
| 7 | 51.432 | 3.911 | 1.531 | 56.0 |
| 8 | ∞ | 0.917 | — | — |
| 9 | ∞ | 0.700 | 1.517 | 64.2 |

TABLE 15
Working example 7/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | — | — | — | — | — | — | — |
| 3 | — | — | — | — | — | — | — |
| 4 | — | — | — | — | — | — | — |
| 5 | — | — | — | — | — | — | — |
| 6 | — | — | — | — | — | — | — |
| 7 | 5.840E+00 | −2.187E−04 | 2.201E−06 | −7.428E−09 | 1.939E−11 | 1.334E−15 | −2.829E−16 |
| 8 | 0 | −3.407E−04 | 1.393E−05 | −1.781E−07 | 9.729E−10 | −2.256E−12 | 1.494E−15 |
| 9 | — | — | — | — | — | — | — |

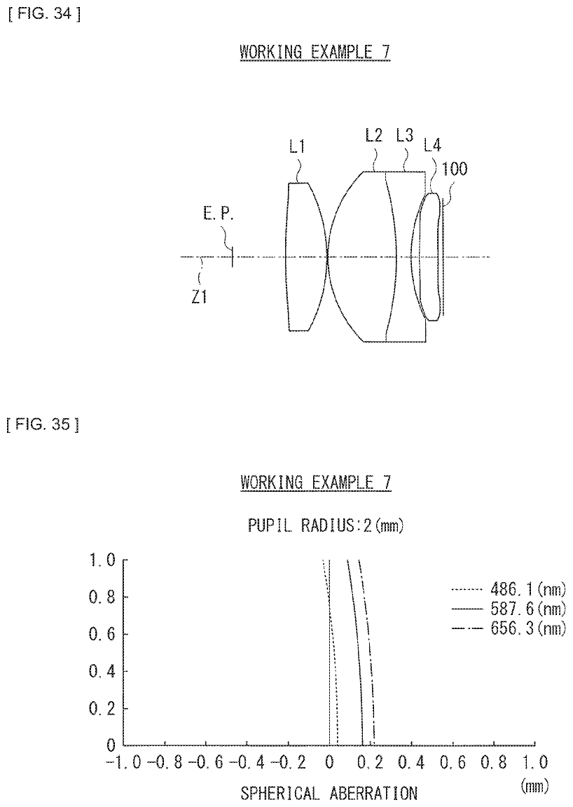

FIG. 34 illustrates a lens cross-section of the eyepiece according to Working example 7.

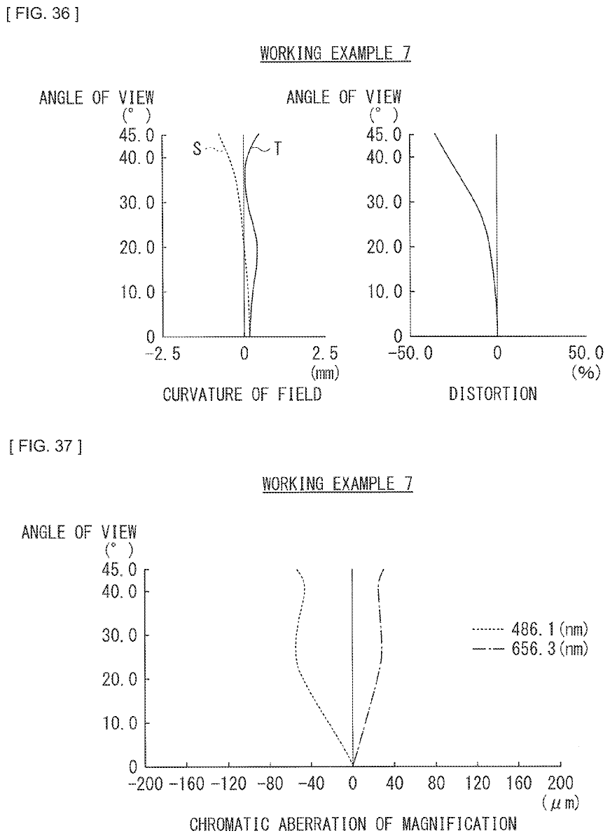

FIGS. 35 to 37 illustrate various aberrations of the eyepiece according to Working example 7.

As can be appreciated from the respective aberration diagrams, it is apparent that the eyepiece according to Working example 7 has a favorable optical performance.

### Working Example 8

Table 16 describes basic lens data of an eyepiece according to Working example 8. Further, Table 17 describes data of aspherical surfaces.

TABLE 16
Working example 8/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 11.000 | — | — |
| 2 | 59.784 | 8.386 | 1.816 | 46.6 |
| 3 | −38.989 | 0.250 | — | — |
| 4 | 26.734 | 12.977 | 1.883 | 40.8 |
| 5 | −28.968 | 4.746 | 1.959 | 17.5 |
| 6 | 23.932 | 0.300 | — | — |
| 7 | 12.688 | 2.382 | 1.531 | 56.0 |
| 8 | 11.999 | 3.573 | — | — |
| 9 | ∞ | 0.700 | 1.517 | 64.2 |

TABLE 17
Working example 8/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | — | — | — | — | — | — | — |
| 3 | — | — | — | — | — | — | — |
| 4 | — | — | — | — | — | — | — |
| 5 | — | — | — | — | — | — | — |
| 6 | — | — | — | — | — | — | — |
| 7 | −1.970E+00 | −2.671E−04 | 7.319E−06 | −1.317E−07 | 1.051E−09 | −2.972E−12 | — |
| 8 | −9.963E−02 | −1.976E−04 | 1.647E−06 | −2.572E−08 | 9.059E−11 | −2.527E−13 | — |
| 9 | — | — | — | — | — | — | — |

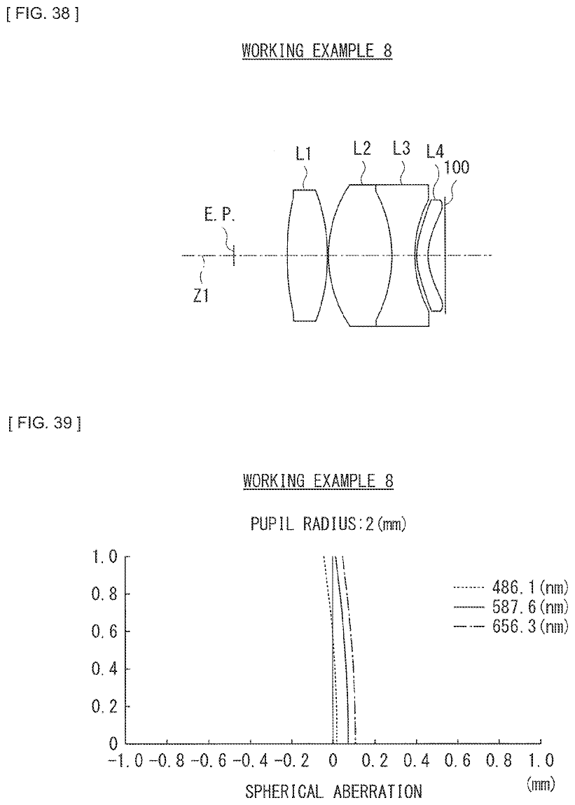

FIG. 38 illustrates a lens cross-section of the eyepiece according to Working example 8.

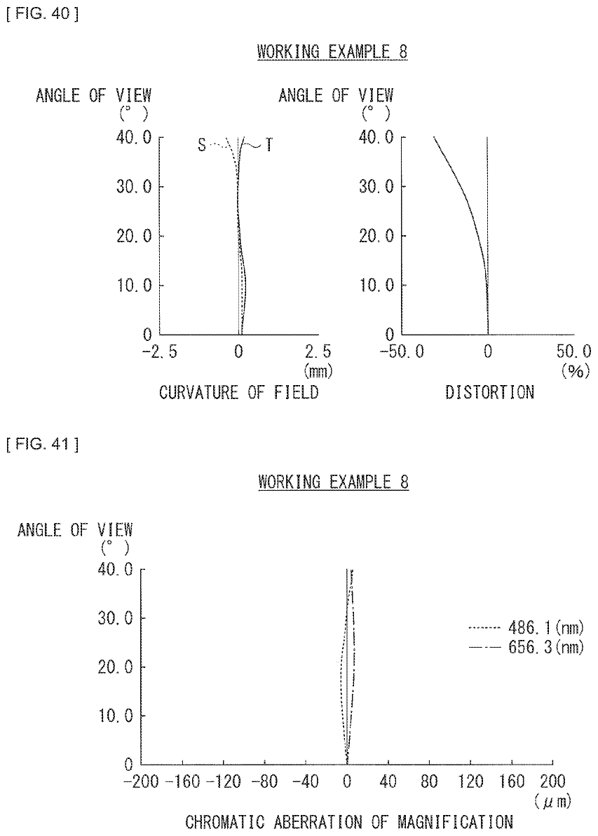

FIGS. 39 to 41 illustrate various aberrations of the eyepiece according to Working example 8.

As can be appreciated from the respective aberration diagrams, it is apparent that the eyepiece according to Working example 8 has a favorable optical performance.

### Working Example 9

Table 18 describes basic lens data of an eyepiece according to Working example 9. Further, Table 19 describes data of aspherical surfaces.

TABLE 18
Working example 9/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 15.000 | — | — |
| 2 | 268.947 | 13.352 | 1.883 | 40.8 |
| 3 | −40.746 | 0.245 | — | — |
| 4 | 29.347 | 21.797 | 1.883 | 40.8 |
| 5 | −49.399 | 1.800 | 1.959 | 17.5 |
| 6 | 91.008 | 4.477 | 2.104 | 17.0 |
| 7 | 64.216 | 3.068 | — | — |
| 8 | ∞ | 0.700 | 1.517 | 64.2 |

TABLE 19
Working example 9/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | 3.236E+01 | 8.385E−06 | −2.232E−08 | 1.108E−11 | −1.978E−16 | — | — |
| 3 | 6.926E−01 | 9.564E−06 | −2.168E−08 | 1.540E−11 | −8.541E−15 | — | — |
| 4 | — | — | — | — | — | — | — |
| 5 | — | — | — | — | — | — | — |
| 6 | — | — | — | — | — | — | — |
| 7 | — | — | — | — | — | — | — |
| 8 | — | — | — | — | — | — | — |

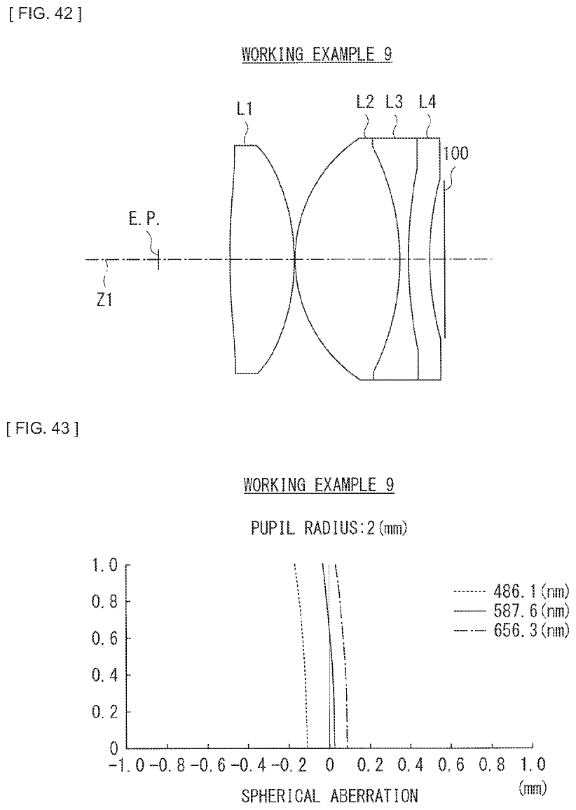

FIG. 42 illustrates a lens cross-section of the eyepiece according to Working example 9.

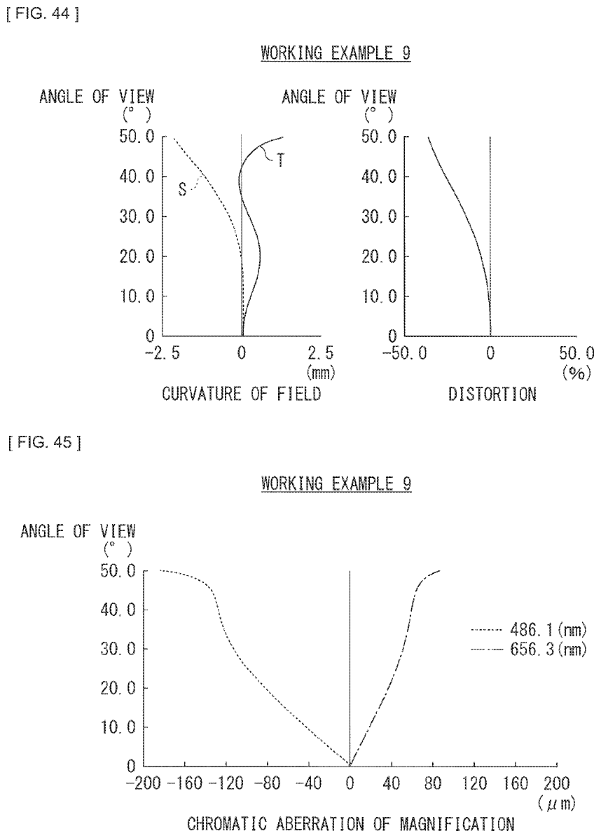

FIGS. 43 to 45 describe various aberrations of the eyepiece according to Working example 9.

As can be appreciated from the respective aberration diagrams, it is apparent that the eyepiece according to Working example 9 has a favorable optical performance.

### Working Example 10

Table 20 describes basic lens data of an eyepiece according to Working example 10. Further, Table 21 describes data of aspherical surfaces.

TABLE 20
Working example 10/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 15.000 | — | — |
| 2 | 241.542 | 11.120 | 1.883 | 40.8 |
| 3 | −36.521 | 0.245 | — | — |
| 4 | 28.261 | 19.189 | 1.883 | 40.8 |
| 5 | −39.764 | 1.800 | 1.959 | 17.5 |
| 6 | 182.412 | 1.800 | 2.104 | 17.0 |
| 7 | 25.821 | 5.590 | — | — |
| 8 | ∞ | 0.700 | 1.517 | 64.2 |

TABLE 21
Working example 10/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | 4.071E+01 | 1.013E−05 | −2.055E−08 | 1.061E−11 | −6.554E−15 | — | — |
| 3 | 4.645E−01 | 1.369E−05 | −1.935E−08 | 1.204E−11 | −1.214E−14 | — | — |
| 4 | — | — | — | — | — | — | — |
| 5 | — | — | — | — | — | — | — |
| 6 | — | — | — | — | — | — | — |
| 7 | — | — | — | — | — | — | — |
| 8 | — | — | — | — | — | — | — |

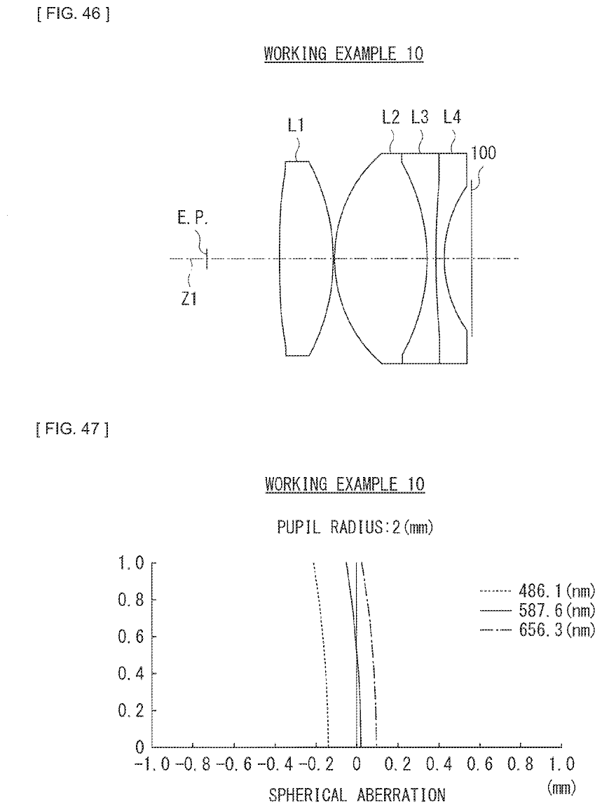

FIG. 46 illustrates a lens cross-section of the eyepiece according to Working example 10.

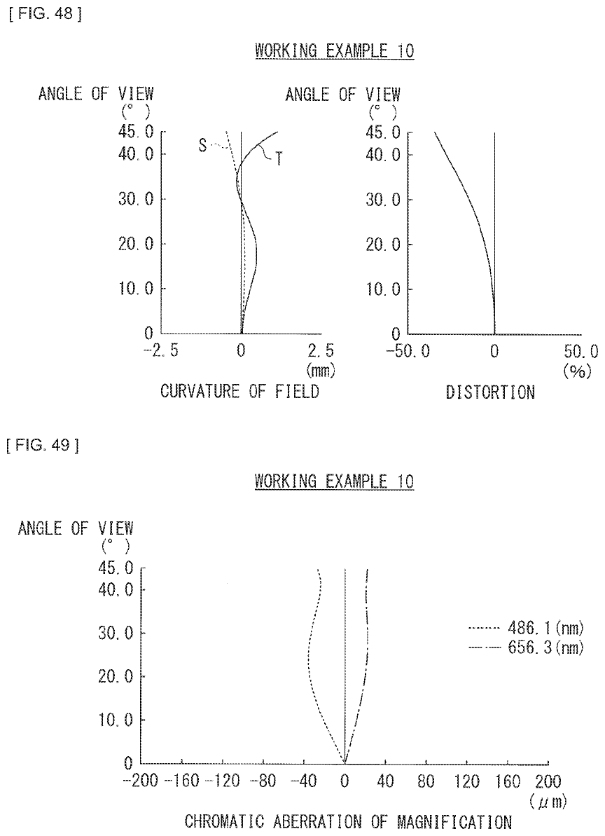

FIGS. 47 to 49 illustrate various aberrations of the eyepiece according to Working example 10.

As can be appreciated from the respective aberration diagrams, it is apparent that the eyepiece according to Working example 10 has a favorable optical performance.

### Working Example 11

Table 22 describes basic lens data of an eyepiece according to Working example 11. Further, Table 23 describes aspherical surfaces.

TABLE 22
Working example 11/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 11.000 | — | — |
| 2 | 128.152 | 11.725 | 1.883 | 40.8 |
| 3 | −31.030 | 0.245 | — | — |
| 4 | 27.833 | 15.203 | 1.883 | 40.8 |
| 5 | −50.168 | 1.800 | 1.959 | 17.5 |
| 6 | 106.071 | 1.800 | 2.104 | 17.0 |
| 7 | 25.037 | 5.567 | — | — |
| 8 | ∞ | 0.700 | 1.517 | 64.2 |

TABLE 23
Working example 11/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | −4.275E−01 | 7.228E−08 | −1.896E−09 | −2.000E−12 | −3.833E−15 | — | — |
| 3 | −2.905E−01 | 4.004E−06 | −8.763E−09 | −3.159E−12 | −7.498E−16 | — | — |
| 4 | — | — | — | — | — | — | — |
| 5 | — | — | — | — | — | — | — |
| 6 | — | — | — | — | — | — | — |
| 7 | — | — | — | — | — | — | — |
| 8 | — | — | — | — | — | — | — |

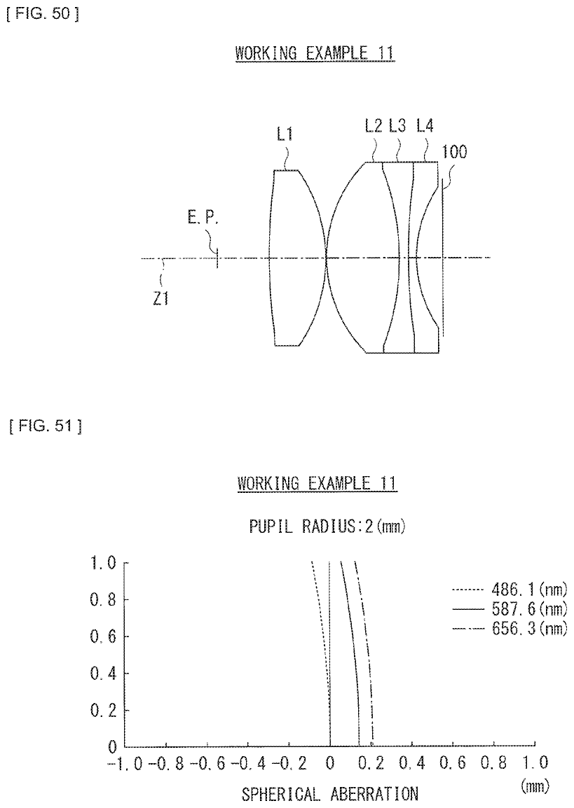

FIG. 50 illustrates a lens cross-section of the eyepiece according to Working example 11.

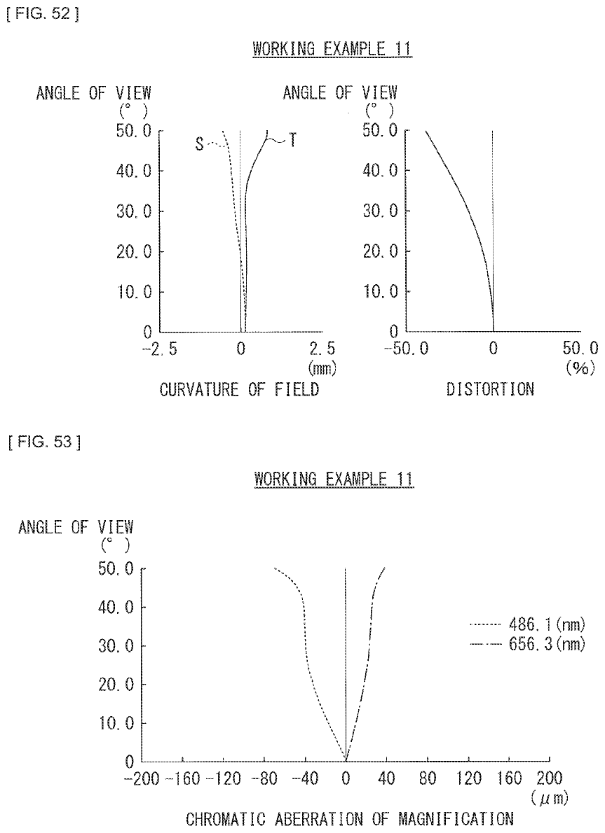

FIGS. 51 to 53 illustrate various aberrations of the eyepiece according to Working example 11.

As can be appreciated from the respective aberration diagrams, it is apparent that the eyepiece according to Working example 11 has a favorable optical performance.

### Working Example 12

Table 24 describes basic lens data of an eyepiece according to Working example 12. Further, Table 25 describes data of aspherical surfaces.

TABLE 24
Working example 12/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 11.000 | — | — |
| 2 | 92.808 | 13.967 | 1.804 | 46.6 |
| 3 | −34.622 | 0.245 | — | — |
| 4 | 30.861 | 16.365 | 1.883 | 40.8 |
| 5 | −33.193 | 1.800 | 1.959 | 17.5 |
| 6 | 26.276 | 3.453 | 2.104 | 17.0 |
| 7 | 25.521 | 5.472 | — | — |
| 8 | ∞ | 0.700 | 1.517 | 64.2 |

TABLE 25
Working example 12/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | 2.039E+01 | −6.283E−06 | 1.738E−08 | −6.038E−11 | −1.065E−13 | — | — |
| 3 | −8.599E−02 | 2.169E−06 | −2.054E−09 | 1.893E−11 | −1.056E−13 | — | — |
| 4 | — | — | — | — | — | — | — |
| 5 | — | — | — | — | — | — | — |
| 6 | — | — | — | — | — | — | — |
| 7 | — | — | — | — | — | — | — |
| 8 | — | — | — | — | — | — | — |

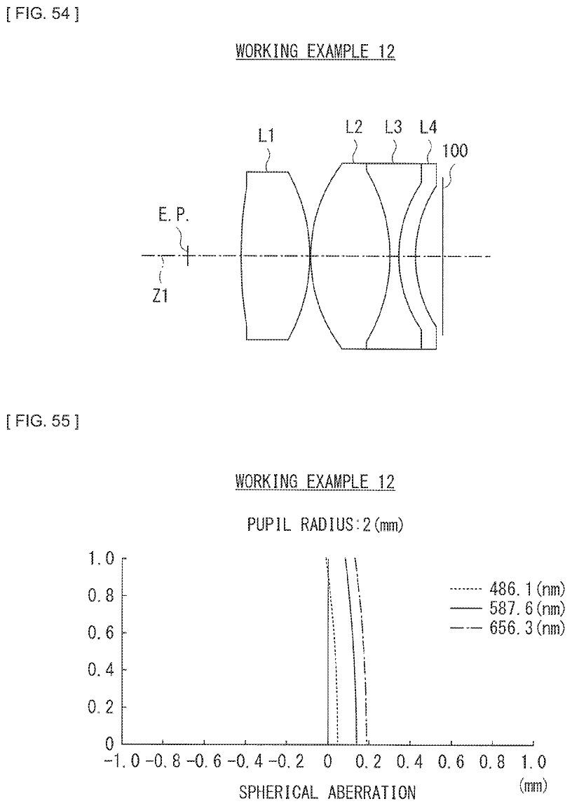

FIG. 54 illustrates a lens cross-section of the eyepiece according to Working example 12.

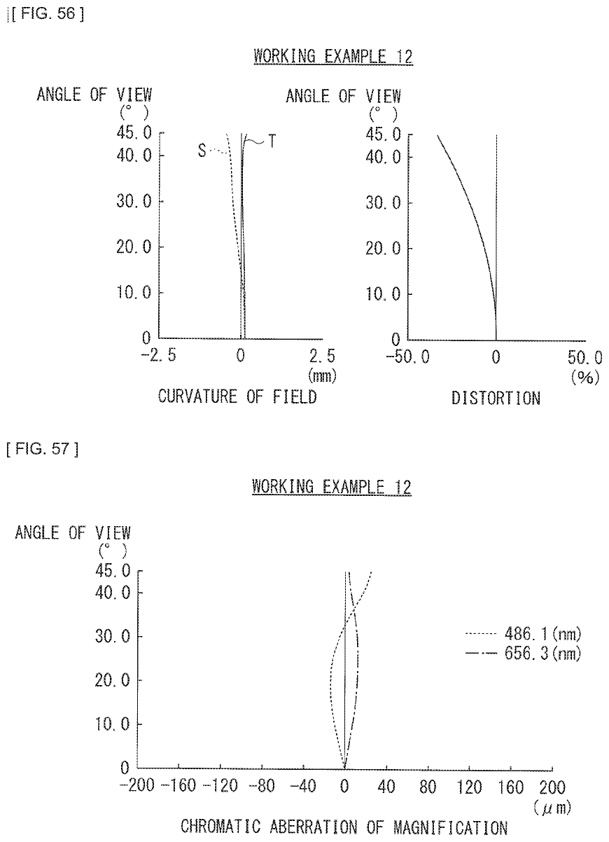

FIGS. 55 to 57 illustrate various aberrations of the eyepiece according to Working example 12.

As can be appreciated from the respective aberration diagrams, it is apparent that the eyepiece according to Working example 12 has a favorable optical performance.

### Working Example 13

Table 26 describes basic lens data of an eyepiece according to Working example 13. Further, Table 27 describes data of aspherical surfaces.

TABLE 26
Working example 13/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 15.000 | — | — |
| 2 | 223.087 | 9.477 | 2.003 | 28.3 |
| 3 | −42.085 | 0.220 | — | — |
| 4 | 24.288 | 12.502 | 1.883 | 40.8 |
| 5 | 78.153 | 6.847 | 2.104 | 17.0 |
| 6 | 19.621 | 7.003 | 1.883 | 40.8 |
| 7 | 237.215 | 1.266 | — | — |
| 8 | ∞ | 0.700 | 1.517 | 64.2 |

TABLE 27
Working example 13/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | −3.636E+01 | 1.441E−05 | −7.490E−08 | 1.033E−10 | −4.109E−14 | — | — |
| 3 | −1.405E+01 | −6.023E−06 | −1.853E−08 | −2.303E−11 | 4.908E−14 | — | — |
| 4 | — | — | — | — | — | — | — |
| 5 | — | — | — | — | — | — | — |
| 6 | — | — | — | — | — | — | — |
| 7 | — | — | — | — | — | — | — |
| 8 | — | — | — | — | — | — | — |

FIG. 58 illustrates a lens cross-section of the eyepiece according to Working example 13.

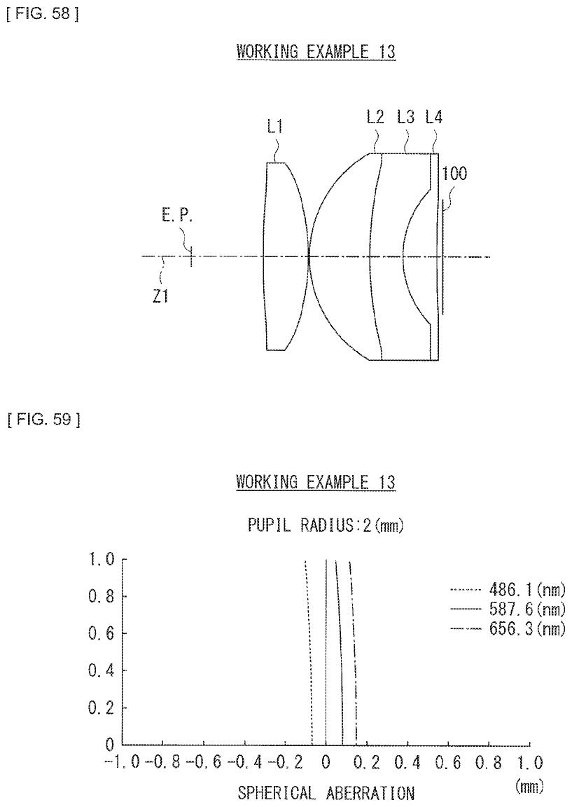

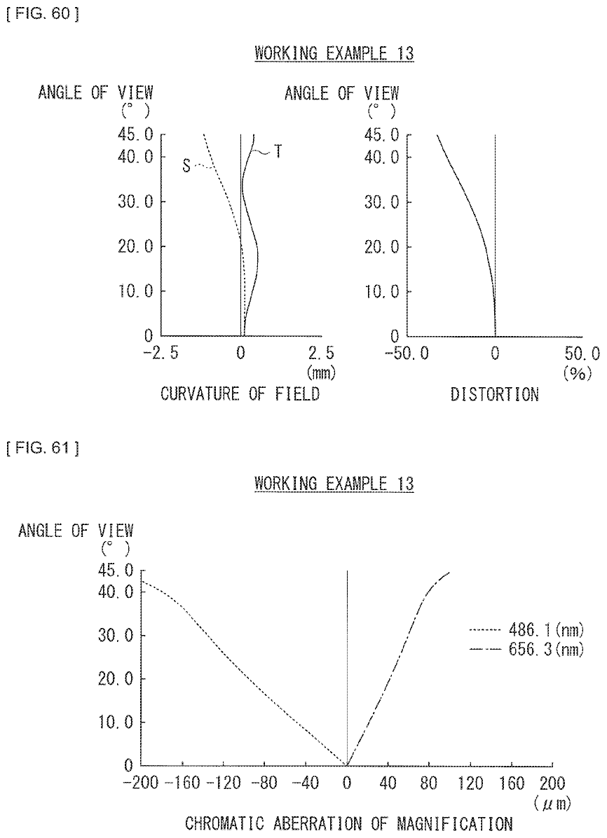

FIGS. 59 to 61 illustrate various aberrations of the eyepiece according to Working example 13.

As can be appreciated from the respective aberration diagrams, it is apparent that the eyepiece according to Working example 13 has a favorable optical performance.

### Working Example 14

Table 28 describes basic lens data of an eyepiece according to Working example 14. Further, Table 29 describes data of aspherical surfaces.

TABLE 28
Working example 14/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 15.000 | — | — |
| 2 | 137.004 | 9.438 | 1.892 | 37.1 |
| 3 | −37.405 | 0.220 | — | — |
| 4 | 22.037 | 12.500 | 1.883 | 40.8 |
| 5 | 241.058 | 1.800 | 2.104 | 17.0 |
| 6 | 13.283 | 7.000 | 1.883 | 40.8 |
| 7 | 26.272 | 3.596 | — | — |
| 8 | ∞ | 0.700 | 1.517 | 64.2 |

TABLE 29
Working example 14/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | 3.996E+01 | 1.332E−05 | −3.675E−08 | 7.878E−11 | −1.889E−13 | — | — |
| 3 | −1.724E+01 | −1.665E−05 | 5.435E−08 | −7.775E−11 | −5.686E−14 | — | — |
| 4 | — | — | — | — | — | — | — |
| 5 | — | — | — | — | — | — | — |
| 6 | — | — | — | — | — | — | — |
| 7 | — | — | — | — | — | — | — |
| 8 | — | — | — | — | — | — | — |

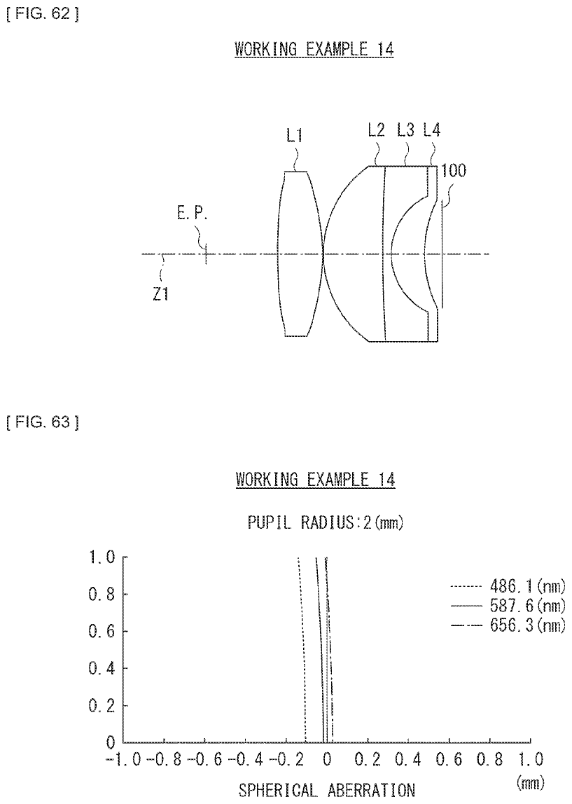

FIG. 62 illustrates a lens cross-section of the eyepiece according to Working example 14.

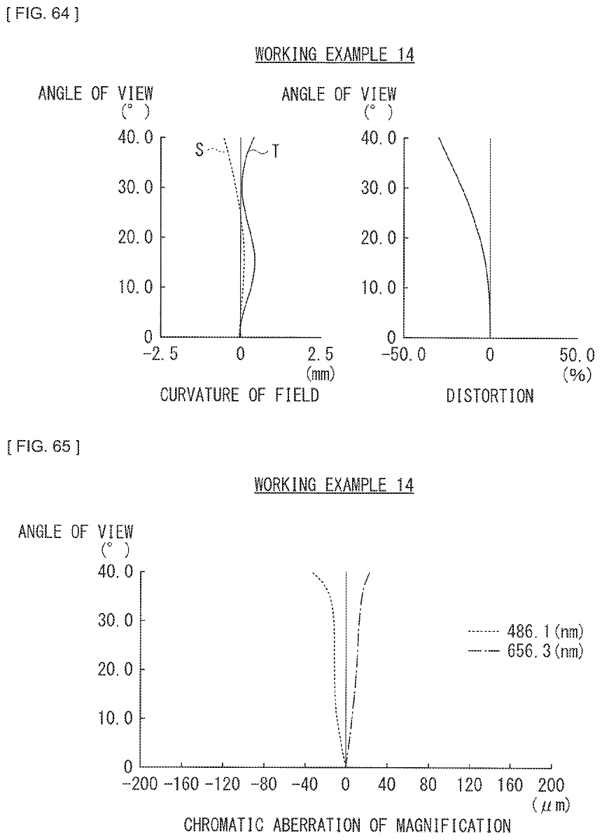

FIGS. 63 to 65 illustrate various aberrations of the eyepiece according to Working example 14.

As can be appreciated from the respective aberration diagrams, it is apparent that the eyepiece according to Working example 14 has a favorable optical performance.

### Working Example 15

Table 30 describes basic lens data of an eyepiece according to Working example 15. Further, Table 31 describes data of aspherical surfaces.

TABLE 30
Working example 15/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 11.000 | — | — |
| 2 | 2672.382 | 8.470 | 1.883 | 40.8 |
| 3 | −28.847 | 0.220 | — | — |
| 4 | 21.360 | 12.500 | 1.883 | 40.8 |
| 5 | 263.933 | 1.800 | 2.104 | 17.0 |
| 6 | 13.931 | 7.000 | 1.883 | 40.8 |
| 7 | 35.580 | 2.891 | — | — |
| 8 | ∞ | 0.700 | 1.517 | 64.2 |

TABLE 31
Working example 15/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | 3.301E+01 | 3.124E−05 | −7.518E−08 | 5.111E−11 | −1.204E−14 | — | — |
| 3 | −6.880E+00 | −3.824E−06 | 2.092E−08 | −1.348E−10 | 9.687E−14 | — | — |
| 4 | — | — | — | — | — | — | — |
| 5 | — | — | — | — | — | — | — |
| 6 | — | — | — | — | — | — | — |
| 7 | — | — | — | — | — | — | — |
| 8 | — | — | — | — | — | — | — |

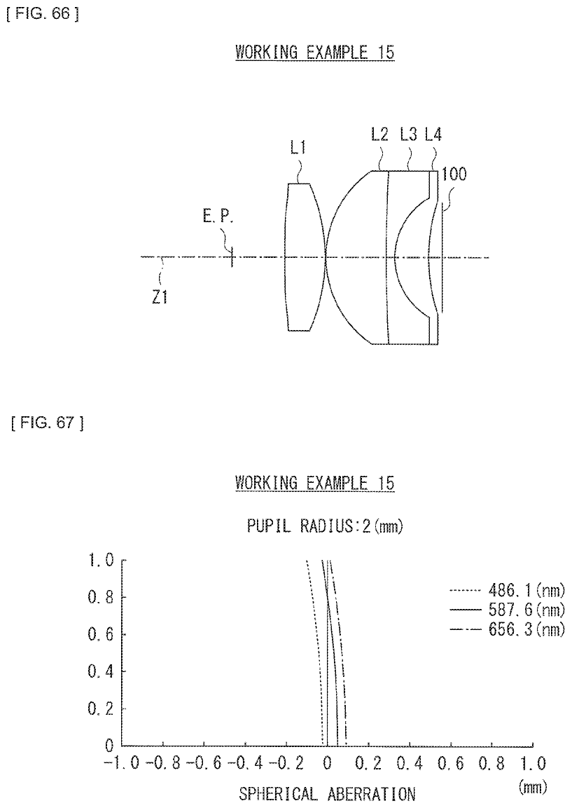

FIG. 66 illustrates a lens cross-section of the eyepiece according to Working example 15.

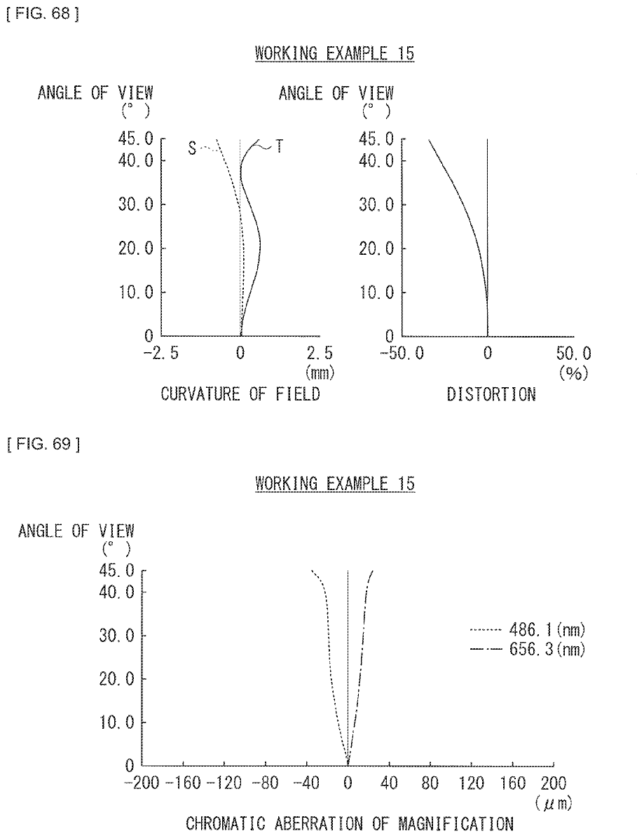

FIGS. 67 to 69 illustrate various aberrations of the eyepiece according to Working example 15.

As can be appreciated from the respective aberration diagrams, it is apparent that the eyepiece according to Working example 15 has a favorable optical performance.

### Working Example 16

Table 32 describes basic lens data of an eyepiece according to Working example 16. Further, Table 33 describes data of aspherical surfaces.

TABLE 32
Working example 16/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 11.000 | — | — |
| 2 | 165.987 | 9.344 | 1.883 | 40.8 |
| 3 | −34.146 | 0.220 | — | — |
| 4 | 22.089 | 12.329 | 1.883 | 40.8 |
| 5 | −82.016 | 4.054 | 2.104 | 17.0 |
| 6 | 14.698 | 4.486 | 1.883 | 40.8 |
| 7 | 24.095 | 3.650 | — | — |
| 8 | ∞ | 0.700 | 1.517 | 64.2 |

TABLE 33
Working example 16/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | −4.000E+01 | 1.749E−05 | −4.710E−09 | 2.795E−11 | −4.333E−13 | — | — |
| 3 | −6.842E+00 | −6.737E−06 | 3.826E−08 | 8.801E−12 | −4.288E−13 | — | — |
| 4 | — | — | — | — | — | — | — |
| 5 | — | — | — | — | — | — | — |
| 6 | — | — | — | — | — | — | — |
| 7 | — | — | — | — | — | — | — |
| 8 | — | — | — | — | — | — | — |

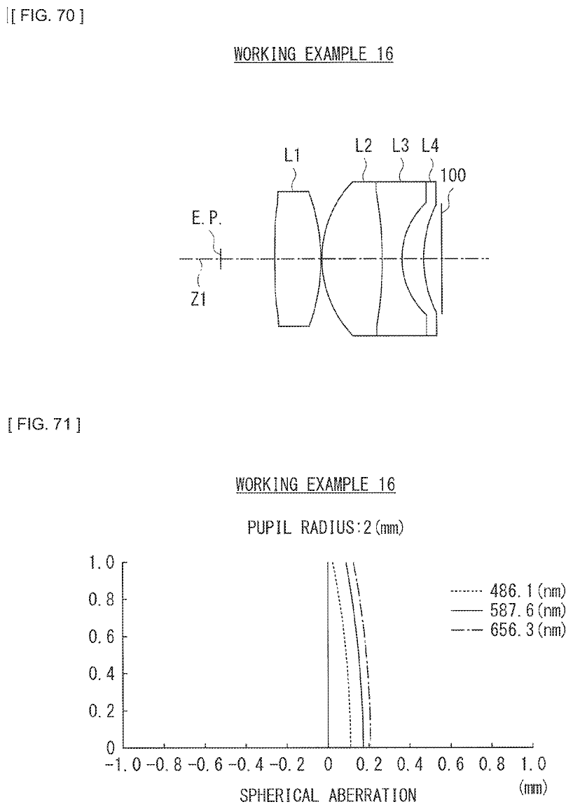

FIG. 70 illustrates a lens cross-section of the eyepiece according to Working example 16.

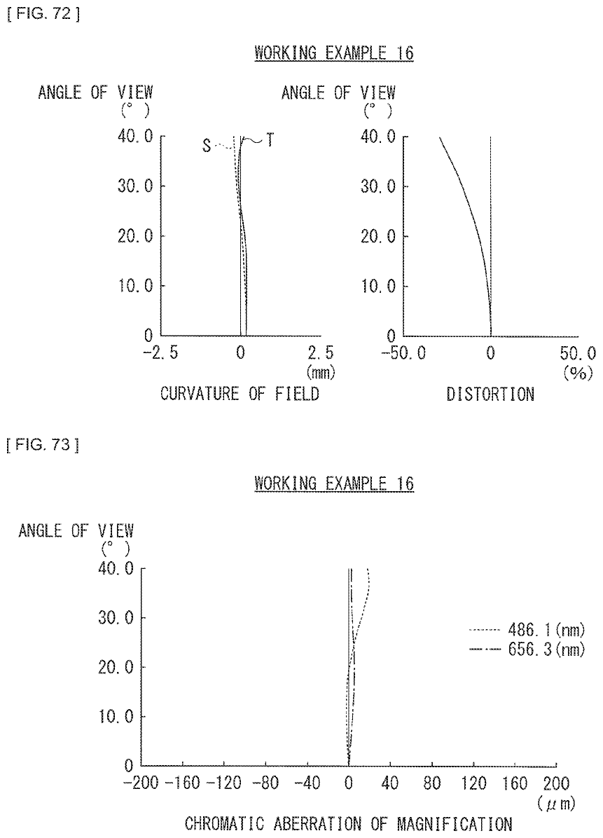

FIGS. 71 to 73 illustrate various aberrations of the eyepiece according to Working example 16.

As can be appreciated from the respective aberration diagrams, it is apparent that the eyepiece according to Working example 16 has a favorable optical performance.

### Working Example 17

Table 34 describes basic lens data of an eyepiece according to Working example 17. Further, Table 35 describes data of aspherical surfaces.

TABLE 34
Working example 17/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 15.000 | — | — |
| 2 | 180.898 | 12.286 | 1.883 | 40.8 |
| 3 | −45.966 | 0.247 | — | — |
| 4 | 30.942 | 25.577 | 1.883 | 40.8 |
| 5 | −41.487 | 7.805 | 1.959 | 17.5 |
| 6 | −392.479 | 0.666 | — | — |
| 7 | ∞ | 0.700 | 1.517 | 64.2 |

TABLE 35
Working example 17/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | −3.377E+01 | 9.494E−06 | −3.066E−08 | 1.797E−11 | −4.606E−16 | — | — |
| 3 | 5.335E−01 | 1.141E−05 | −2.933E−08 | 2.142E−11 | −1.751E−14 | — | — |
| 4 | — | — | — | — | — | — | — |
| 5 | — | — | — | — | — | — | — |
| 6 | — | — | — | — | — | — | — |
| 7 | — | — | — | — | — | — | — |

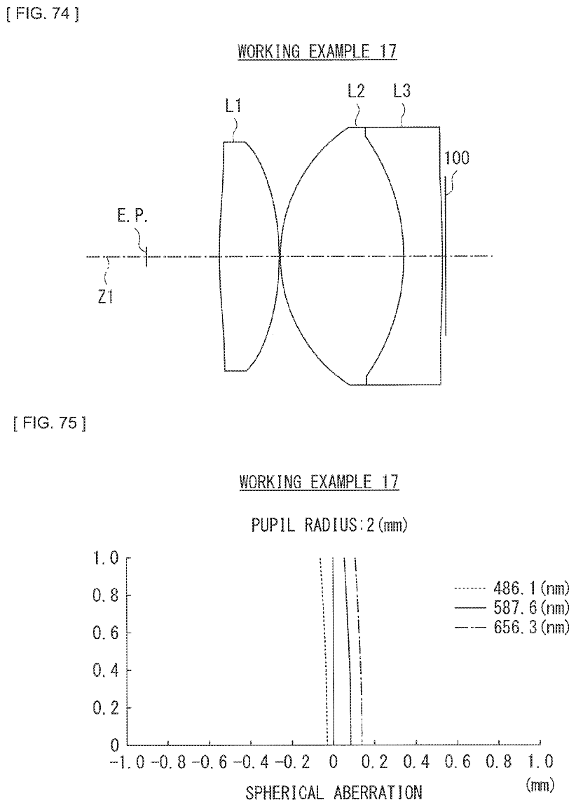

FIG. 74 illustrates a lens cross-section of the eyepiece according to Working example 17.

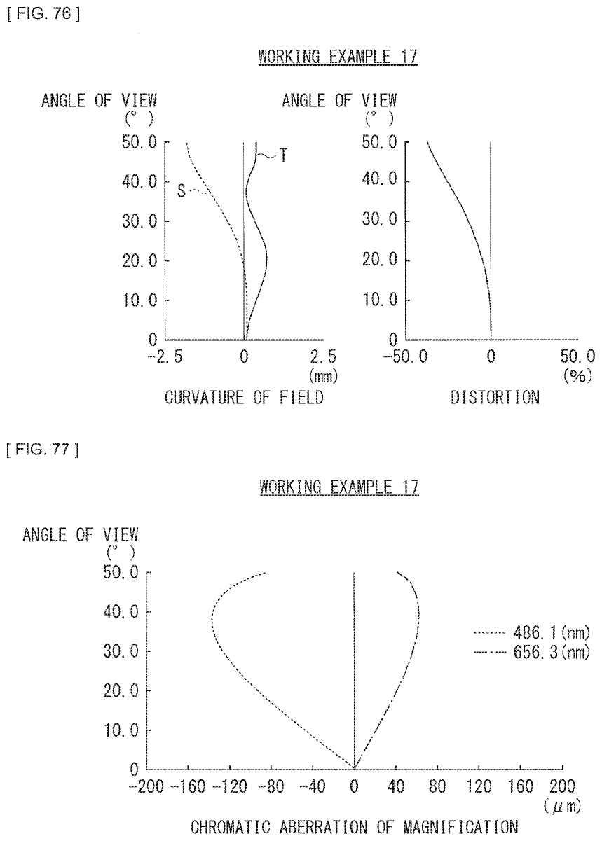

FIGS. 75 to 77 illustrate various aberrations of the eyepiece according to Working example 17.

As can be appreciated from the respective aberration diagrams, it is apparent that the eyepiece according to Working example 17 has a favorable optical performance.

### Working Example 18

Table 36 describes basic lens data of an eyepiece according to Working example 18. Further, Table 37 describes data of aspherical surfaces.

TABLE 36
Working example 18/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 15.000 | — | — |
| 2 | 230.256 | 11.333 | 1.883 | 40.8 |
| 3 | −36.638 | 0.249 | — | — |
| 4 | 27.707 | 19.682 | 1.883 | 40.8 |
| 5 | −37.911 | 1.800 | 1.959 | 17.5 |
| 6 | 23.664 | 6.108 | — | — |
| 7 | ∞ | 0.700 | 1.517 | 64.2 |

TABLE 37
Working example 18/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | 9.010E+01 | 9.738E−06 | −1.613E−08 | 1.266E−11 | −3.218E−14 | — | — |
| 3 | −1.890E−01 | 1.086E−05 | −1.130E−08 | 1.234E−11 | −3.653E−14 | — | — |
| 4 | — | — | — | — | — | — | — |
| 5 | — | — | — | — | — | — | — |
| 6 | — | — | — | — | — | — | — |
| 7 | — | — | — | — | — | — | — |

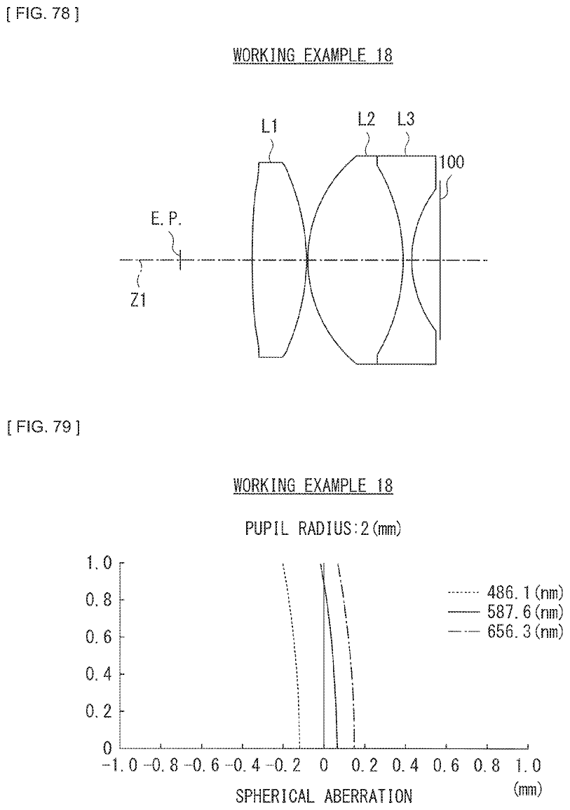

FIG. 78 illustrates a lens cross-section of the eyepiece according to Working example 18.

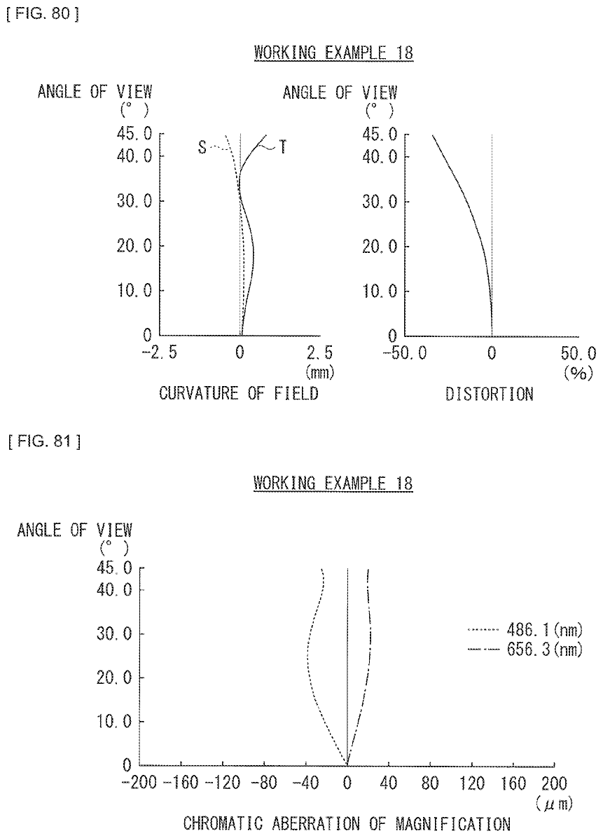

FIGS. 79 to 81 illustrate various aberrations of the eyepiece according to Working example 18.

As can be appreciated from the respective aberration diagrams, it is apparent that the eyepiece according to Working example 18 has a favorable optical performance.

### Working Example 19

Table 38 describes basic lens data of an eyepiece according to Working example 19. Further, Table 39 describes data of aspherical surfaces.

TABLE 38
Working example 19/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 11.000 | — | — |
| 2 | 207.997 | 11.098 | 1.883 | 40.8 |
| 3 | −31.321 | 0.249 | — | — |
| 4 | 26.973 | 17.305 | 1.883 | 40.8 |
| 5 | −37.894 | 1.800 | 1.959 | 17.5 |
| 6 | 24.537 | 5.840 | — | — |
| 7 | ∞ | 0.700 | 1.517 | 64.2 |

TABLE 39
Working example 19/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | 8.698E+01 | 1.171E−05 | −3.025E−08 | −1.968E−12 | −6.019E−15 | — | — |
| 3 | −1.826E−01 | 1.381E−05 | −1.665E−08 | −1.574E−11 | −2.398E−14 | — | — |
| 4 | — | — | — | — | — | — | — |
| 5 | — | — | — | — | — | — | — |
| 6 | — | — | — | — | — | — | — |
| 7 | — | — | — | — | — | — | — |

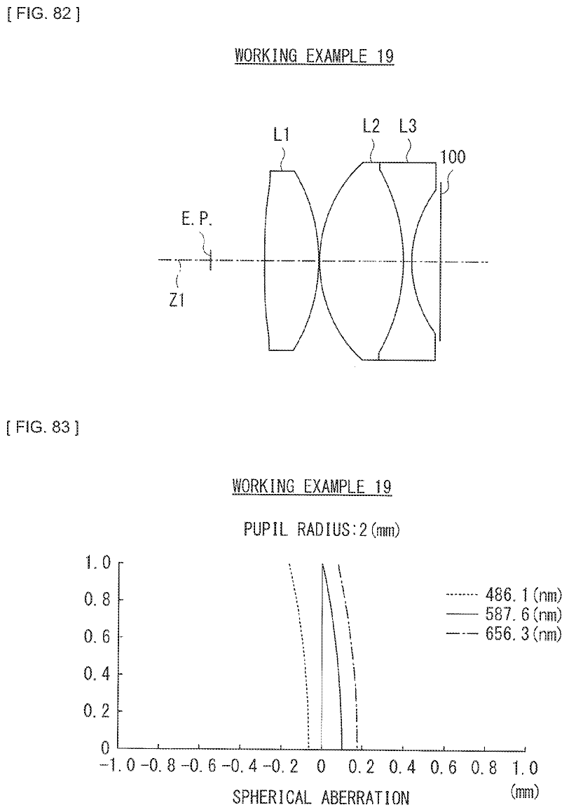

FIG. 82 illustrates a lens cross-section of the eyepiece according to Working example 19.

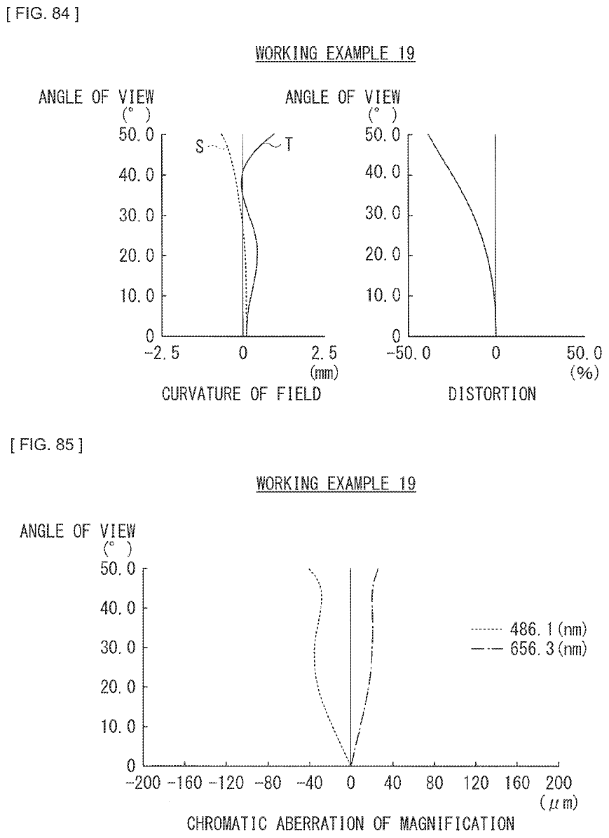

FIGS. 83 to 85 illustrate various aberrations of the eyepiece according to Working example 19.

As can be appreciated from the respective aberration diagrams, it is apparent that the eyepiece according to Working example 19 has a favorable optical performance.

### Working Example 20

Table 40 describes basic lens data of an eyepiece according to Working example 20. Further, Table 41 describes data of aspherical surfaces.

TABLE 40
Working example 20/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 11.000 | — | — |
| 2 | 119.200 | 9.339 | 1.883 | 40.8 |
| 3 | −38.320 | 0.250 | — | — |
| 4 | 32.998 | 16.071 | 1.883 | 40.8 |
| 5 | −28.185 | 8.420 | 1.959 | 17.5 |
| 6 | 29.141 | 4.747 | — | — |
| 7 | ∞ | 0.700 | 1.517 | 64.2 |

TABLE 41
Working example 20/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | 3.158E+01 | 1.265E−06 | −7.858E−10 | 2.379E−11 | −7.345E−14 | — | — |
| 3 | 4.477E−01 | 6.338E−06 | −9.791E−10 | 2.748E−12 | 2.554E−14 | — | — |
| 4 | — | — | — | — | — | — | — |
| 5 | — | — | — | — | — | — | — |
| 6 | — | — | — | — | — | — | — |
| 7 | — | — | — | — | — | — | — |

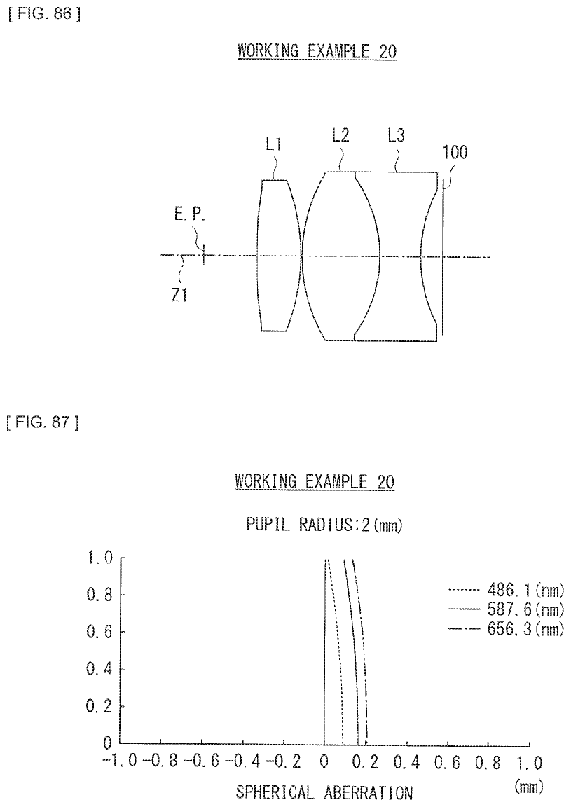

FIG. 86 illustrates a lens cross-section of the eyepiece according to Working example 20.

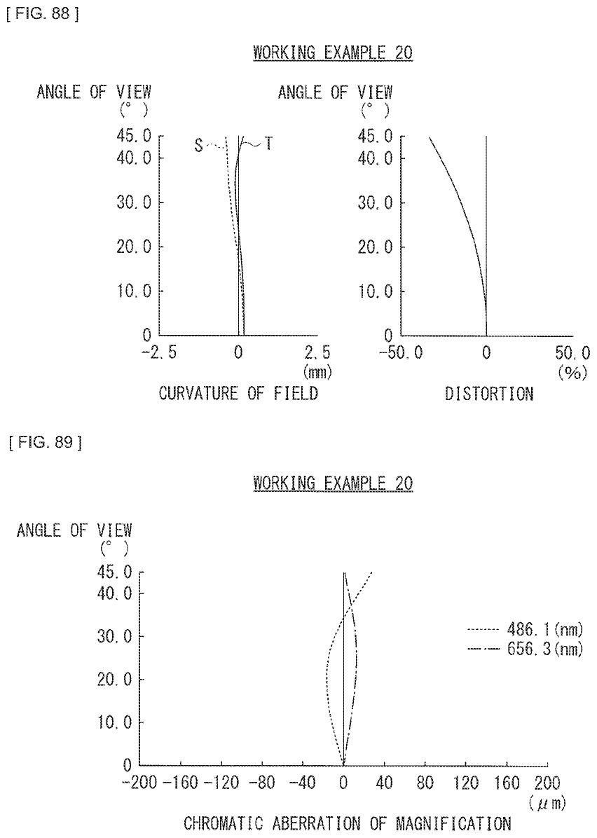

FIGS. 87 to 89 illustrate various aberrations of the eyepiece according to Working example 20.

As can be appreciated from the respective aberration diagrams, it is apparent that the eyepiece according to Working example 20 has a favorable optical performance.

### Working Example 21

Table 42 describes basic lens data of an eyepiece according to Working example 21. Further, Table 43 describes data of aspherical surfaces.

TABLE 42
Working example 21/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 15.000 | — | — |
| 2 | 116.892 | 11.001 | 1.883 | 40.8 |
| 3 | −41.417 | 0.250 | — | — |
| 4 | 25.040 | 12.502 | 1.883 | 40.8 |
| 5 | 105.633 | 13.354 | 2.104 | 17.0 |
| 6 | 118.753 | 1.671 | — | — |
| 7 | ∞ | 0.700 | 1.517 | 64.2 |

TABLE 43
Working example 23/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | 1.971E+00 | −1.382E−06 | −2.513E−08 | 2.724E−11 | — | — | — |
| 3 | 1.107E+00 | 3.591E−06 | −3.345E−08 | 2.851E−11 | — | — | — |
| 4 | — | — | — | — | — | — | — |
| 5 | — | — | — | — | — | — | — |
| 6 | — | — | — | — | — | — | — |
| 7 | — | — | — | — | — | — | — |

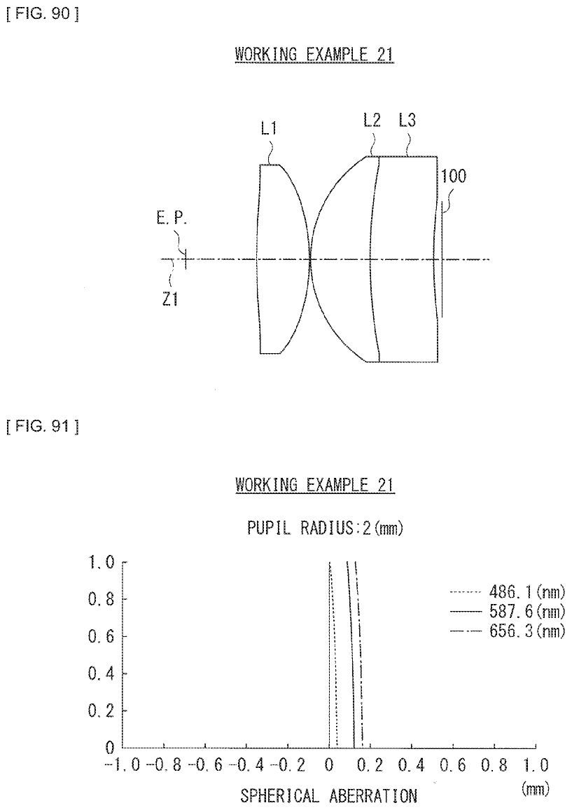

FIG. 90 illustrates a lens cross-section of the eyepiece according to Working example 21.

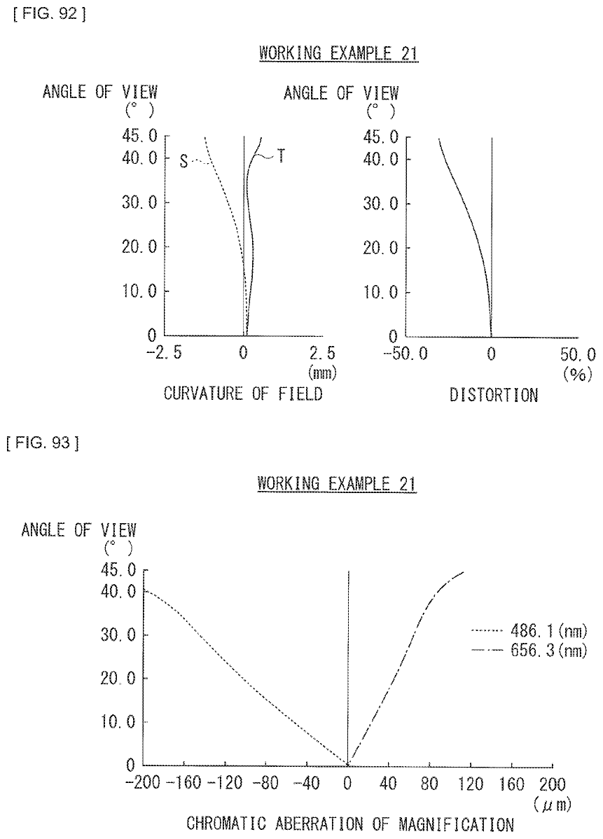

FIGS. 91 to 93 illustrate various aberrations of the eyepiece according to Working example 21.

As can be appreciated from the respective aberration diagrams, it is apparent that the eyepiece according to Working example 21 has a favorable optical performance.

### Working Example 22

Table 44 describes basic lens data of an eyepiece according to Working example 22. Further, Table 45 describes data of aspherical surfaces.

TABLE 44
Working example 22/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 15.000 | — | — |
| 2 | 89.086 | 10.640 | 1.883 | 40.8 |
| 3 | −36.836 | 0.250 | — | — |
| 4 | 22.032 | 12.501 | 1.883 | 40.8 |
| 5 | −198.616 | 5.735 | 2.104 | 17.0 |
| 6 | 19.329 | 4.688 | — | — |
| 7 | ∞ | 0.700 | 1.517 | 64.2 |

TABLE 45
Working example 22/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | 1.334E+01 | 1.011E−05 | −2.517E−08 | −1.291E−11 | — | — | — |
| 3 | −8.086E−01 | 1.632E−05 | −3.832E−08 | 6.144E−12 | — | — | — |
| 4 | — | — | — | — | — | — | — |
| 5 | — | — | — | — | — | — | — |
| 6 | — | — | — | — | — | — | — |
| 7 | — | — | — | — | — | — | — |

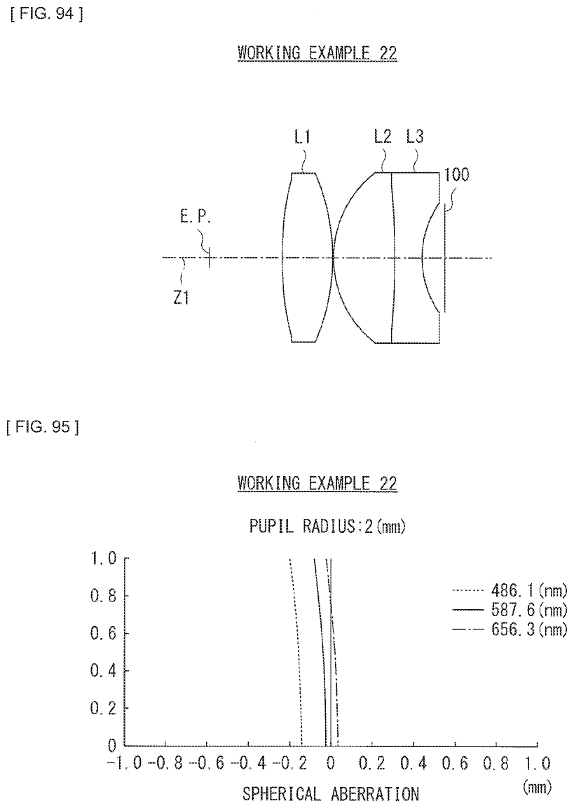

FIG. 94 illustrates a lens cross-section of the eyepiece according to Working example 22.

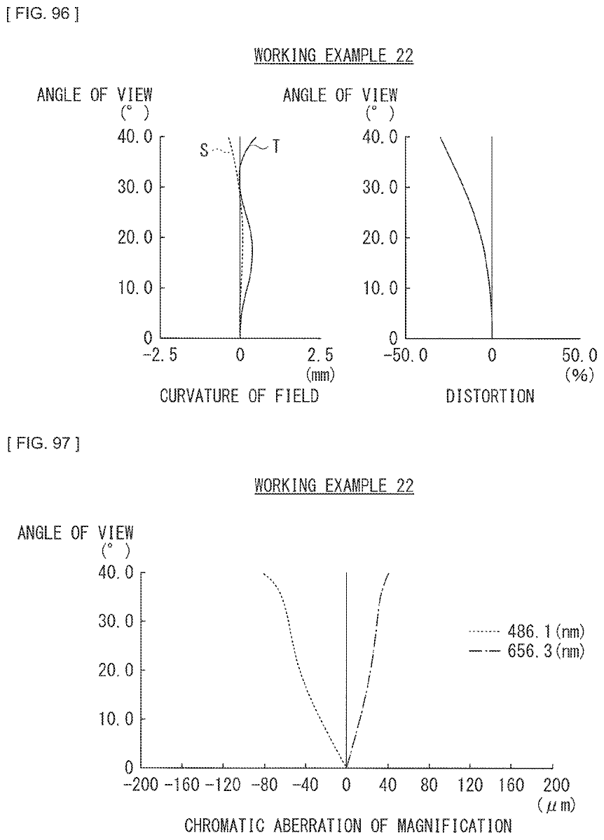

FIGS. 95 to 97 illustrate various aberrations of the eyepiece according to Working example 22.

As can be appreciated from the respective aberration diagrams, it is apparent that the eyepiece according to Working example 22 has a favorable optical performance.

### Working Example 23

Table 46 describes basic lens data of an eyepiece according to Working example 23. Further, Table 47 describes data of aspherical surfaces.

TABLE 46
Working example 23/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 11.000 | — | — |
| 2 | 126.788 | 10.173 | 1.883 | 40.8 |
| 3 | −29.667 | 0.250 | — | — |
| 4 | 20.797 | 12.501 | 1.883 | 40.8 |
| 5 | −109.660 | 4.216 | 2.104 | 17.0 |
| 6 | 21.512 | 4.322 | — | — |
| 7 | ∞ | 0.700 | 1.517 | 64.2 |

TABLE 47
Working example 23/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | 3.761E+01 | 2.533E−05 | −7.354E−08 | −2.881E−12 | — | — | — |
| 3 | −1.122E+00 | 2.409E−05 | −5.945E−08 | −2.180E−11 | — | — | — |
| 4 | — | — | — | — | — | — | — |
| 5 | — | — | — | — | — | — | — |
| 6 | — | — | — | — | — | — | — |
| 7 | — | — | — | — | — | — | — |

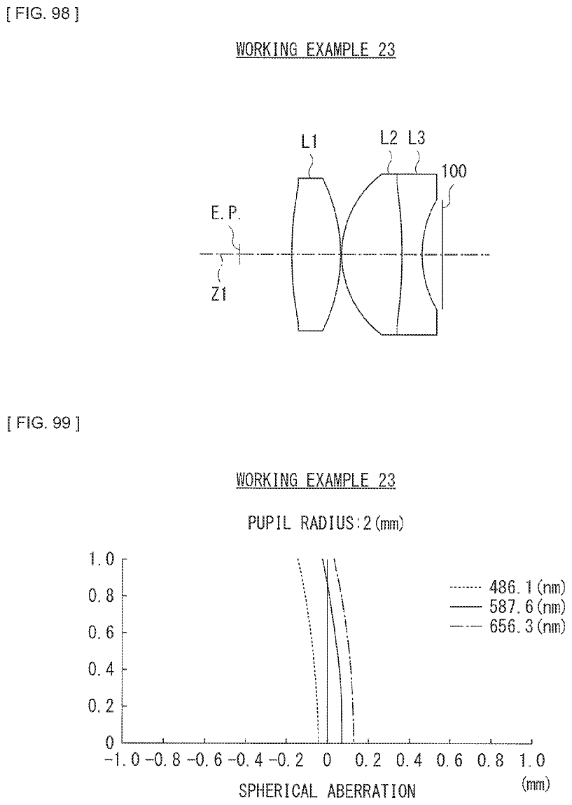

FIG. 98 illustrates a lens cross-section of the eyepiece according to Working example 23.

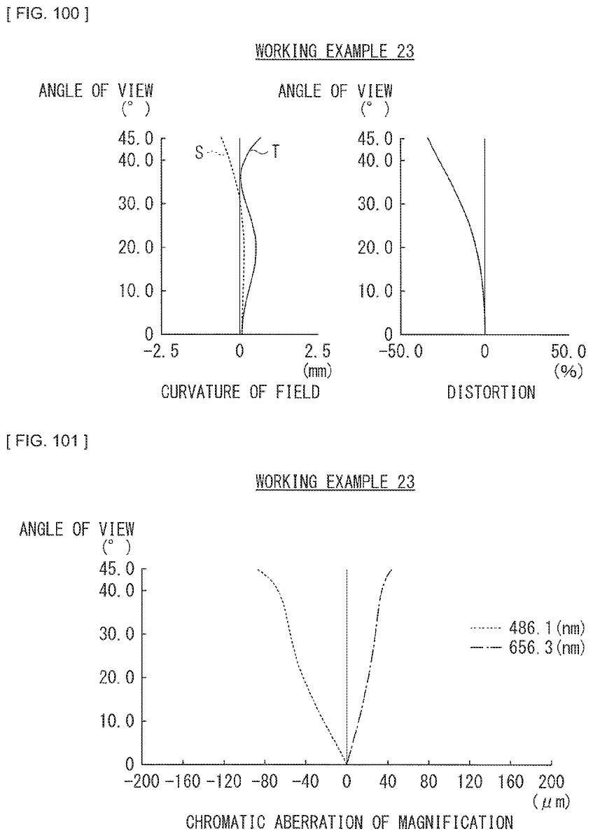

FIGS. 99 to 101 illustrate various aberrations of the eyepiece according to Working example 23.

As can be appreciated from the respective aberration diagrams, it is apparent that the eyepiece according to Working example 23 has a favorable optical performance.

### Working Example 24

Table 48 describes basic lens data of an eyepiece according to Working example 24. Further, Table 49 describes data of aspherical surfaces.

TABLE 48
Working example 24/Lens data

| | Ri | | Ndi | νdi |
|---|---|---|---|---|
| Si | Radius of | Di | Refractive | Abbe's |
| Plane number | curvature | Distance | index | number |
| 1(STO) | ∞ | 11.000 | — | — |
| 2 | 79.876 | 8.389 | 1.883 | 40.8 |
| 3 | −35.059 | 0.250 | — | — |
| 4 | 23.522 | 12.500 | 1.883 | 40.8 |
| 5 | −31.405 | 7.027 | 2.104 | 17.0 |
| 6 | 21.847 | 3.859 | — | — |
| 7 | ∞ | 0.700 | 1.517 | 64.2 |

TABLE 49
Working example 24/Aspherical surface data

| Si | | | | | | | |
|---|---|---|---|---|---|---|---|
| Plane | K | 4-th | 6-th | 8-th | 10-th | 12-th | 14-th |
| number | Cone constant | order | order | order | order | order | order |
| 1 | — | — | — | — | — | — | — |
| (STO) | | | | | | | |
| 2 | 1.481E+01 | 6.208E−06 | 1.420E−08 | −8.040E−11 | — | — | — |
| 3 | 3.836E−01 | 1.273E−05 | 5.379E−09 | −2.226E−11 | — | — | — |
| 4 | — | — | — | — | — | — | — |
| 5 | — | — | — | — | — | — | — |
| 6 | — | — | — | — | — | — | — |
| 7 | — | — | — | — | — | — | — |

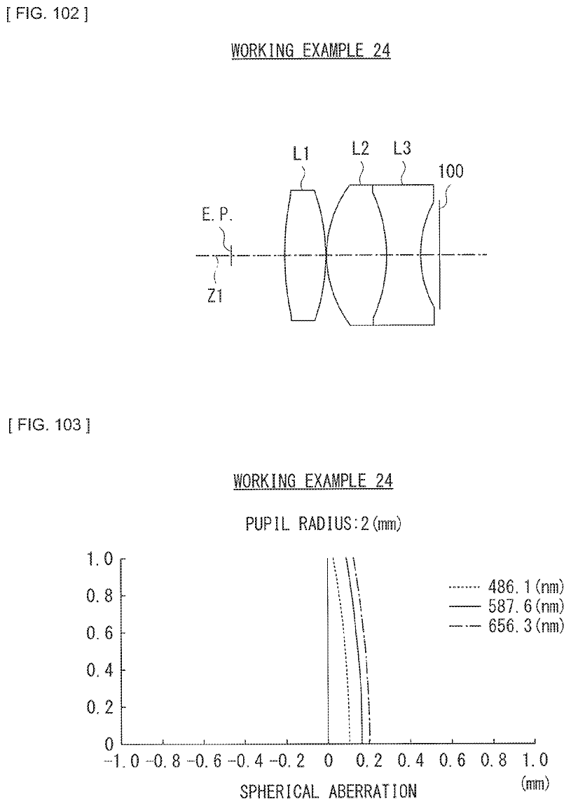

FIG. 102 illustrates a lens cross-section of the eyepiece according to Working example 24.

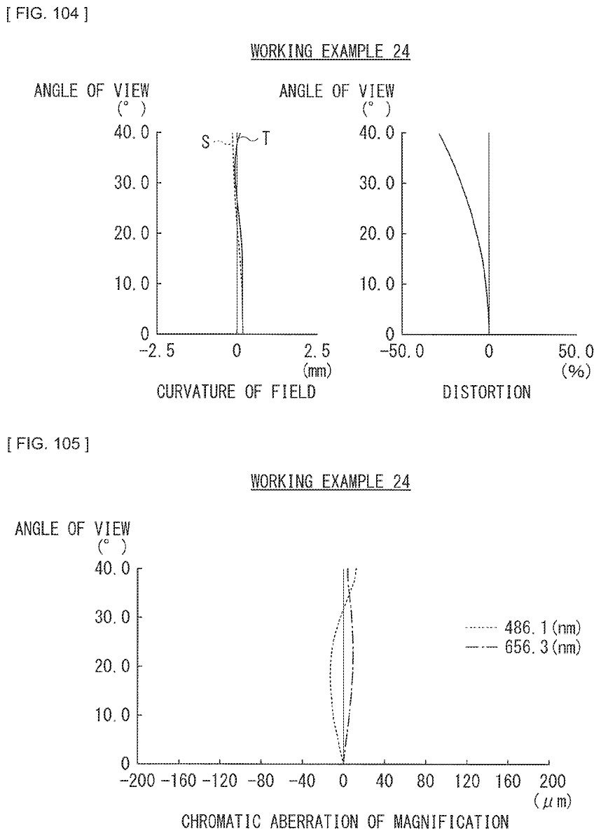

FIGS. 103 to 105 illustrate various aberrations of the eyepiece according to Working example 24.

As can be appreciated from the respective aberration diagrams, it is apparent that the eyepiece according to Working example 24 has a favorable optical performance.

### Other Numerical Data for Each Working Example

Table 50 describes a summary, for each working example, of values of other numerical data (such as values related to the conditional expressions) satisfied by the eyepiece according to each working example. As can be appreciated from Table 50, a desired configuration is satisfied in each working example. It is to be noted that satisfying the above-described conditional expression (1) means that the image magnification Mv becomes 2.2× or greater. As described in Table 50, the image magnification Mv of each working example is 2.2× or greater, which satisfies the conditional expression (1).

TABLE 50

| | Working | Working | Working | Working | Working | Working | Working | Working |
|---|---|---|---|---|---|---|---|---|
| | example | example | example | example | example | example | example | example |
| | 1 | 2 | 3 | 4 | 5 | 6 | 7 | 8 |
| L [mm] | 61.03 | 56.74 | 49.57 | 49.39 | 53.52 | 51.95 | 44.34 | 44.31 |
| f [mm] | 40.98 | 38.27 | 34.37 | 35.40 | 36.04 | 35.77 | 30.91 | 30.07 |
| Mv | 3.39 | 2.84 | 2.78 | 2.50 | 3.62 | 3.12 | 3.02 | 2.68 |
| f/(L-ER) | 0.89 | 0.92 | 0.89 | 0.92 | 0.94 | 0.97 | 0.93 | 0.90 |
| t′/L′ | 0.98 | 0.85 | 0.83 | 0.83 | 0.94 | 0.92 | 0.91 | 0.87 |
| Power arrangement | +/− | +/− | +/− | +/− | +/− | +/− | +/− | +/− |
| of cemented lens | | | | | | | | |
| Minimum refractive | 1.883 | 1.883 | 1.883 | 1.755 | 1.883 | 1.816 | 1.883 | 1.816 |
| index of L1-3 | | | | | | | | |
| Shape of surface of | convex | convex | convex | convex | convex | convex | convex | convex |
| L1 on E.P. side | | | | | | | | |
| | Working | Working | Working | Working | Working | Working | Working | Working |
| | example | example | example | example | example | example | example | example |
| | 9 | 10 | 11 | 12 | 13 | 14 | 15 | 16 |
| L [mm] | 60.44 | 55.44 | 48.04 | 53.00 | 53.02 | 50.25 | 44.58 | 45.78 |
| f [mm] | 40.90 | 36.62 | 29.30 | 32.97 | 35.93 | 33.81 | 32.37 | 32.79 |
| Mv | 3.36 | 2.78 | 2.70 | 2.67 | 3.98 | 3.40 | 3.37 | 3.11 |
| f/(L-ER) | 0.90 | 0.91 | 0.79 | 0.79 | 0.95 | 0.96 | 0.96 | 0.94 |
| t′/L′ | 0.88 | 0.93 | 0.93 | 0.90 | 0.79 | 0.78 | 0.76 | 0.84 |
| Power arrangement | +/−/− | +/−/− | +/−/− | +/−/− | +/−/+ | +/−/− | +/−/− | +/−/− |
| of cemented lens | | | | | | | | |
| Minimum refractive | 1.883 | 1.883 | 1.883 | 1.804 | 2.000 | 1.883 | 1.883 | 1.883 |
| index of L1-4 | | | | | | | | |
| Shape of surface of | convex | convex | convex | convex | convex | convex | convex | convex |
| L1 on E.P. side | | | | | | | | |
| | Working | Working | Working | Working | Working | Working | Working | Working |
| | example | example | example | example | example | example | example | example |
| | 17 | 18 | 19 | 20 | 21 | 22 | 23 | 24 |
| L [mm] | 62.28 | 54.87 | 47.99 | 50.53 | 54.48 | 49.51 | 43.16 | 43.73 |
| f [mm] | 42.59 | 36.52 | 31.51 | 33.78 | 35.80 | 30.73 | 28.08 | 28.57 |
| Mv | 3.11 | 2.45 | 2.43 | 2.27 | 4.09 | 3.35 | 3.27 | 2.98 |
| f/(L-ER) | 0.90 | 0.92 | 0.85 | 0.85 | 0.91 | 0.89 | 0.87 | 0.87 |
| t′/L′ | 0.98 | 0.84 | 0.84 | 0.87 | 0.95 | 0.86 | 0.86 | 0.87 |
| Power arrangement | +/− | +/− | +/− | +/− | +/− | +/− | +/− | +/− |
| of cemented lens | | | | | | | | |
| Minimum refractive | 1.883 | 1.883 | 1.883 | 1.883 | 1.883 | 1.883 | 1.883 | 1.883 |
| index of L1-3 | | | | | | | | |
| Shape of surface of | convex | convex | convex | convex | convex | convex | convex | convex |
| L1 on E.P. side | | | | | | | | |

### [5. Other Embodiments]

The technology according to the present disclosure is not limited to the description of the above-mentioned embodiments and working examples, and various modifications can be made.

For example, the shapes and numerical values of the respective parts described in the above numerical working examples are mere examples of the implementation of the present technology, and the technical scope of the present technology should not be construed as being limited by these examples.

Further, in the above-described embodiments and working examples, the configuration substantially including three or four lenses has been described; however, a configuration further including a lens having substantially no refractive power may be employed.

Further, a surface forming an aspherical surface is not limited to the lens surface described in each working example, and any surface other than the lens surface described in each working example may be an aspherical surface.

Further, for example, it is possible for the present technology to be configured as follows.

[1]

An eyepiece including three or more lenses provided in order from side of an eye point toward side of an image,
at least two of the three or more lenses configuring a cemented lens,
one of the three or more lenses being an aspherical lens, in which
the following conditional expressions are satisfied,

ω′/(tan⁻¹⁽h/L))≥2.2 (1)

ω′≥0.698 (2)

where “ω′” is a half value (rad) of a maximum field-of-view angle,
“h” is a maximum image height, and
“L” is a distance from the eye point to the image.
   [2]

The eyepiece according to [1] described above, in which the three or more lenses include
a first lens,
a second lens,
a third lens, and
a fourth lens
that are provided in order from the side of the eye point toward the side of the image,
the second lens and the third lens configure the cemented lens, and
the fourth lens is the aspherical lens.
   [3]

The eyepiece according to [1] described above, in which the three or more lenses include
a first lens,
a second lens,
a third lens, and
a fourth lens
that are provided in order from the side of the eye point toward the side of the image,
the second lens, the third lens, and the fourth lens configure the cemented lens, and
the first lens is the aspherical lens.

The eyepiece according to [1] described above, in which the three or more lenses include
a first lens,
a second lens, and
a third lens,
that are provided in order from the side of the eye point toward the side of the image,
the second lens and the third lens configure the cemented lens, and
the first lens is the aspherical lens.
   [5]

The eyepiece according to [2] described above, in which the second lens has a positive refractive power, and the third lens has a negative refractive power.

[6]

The eyepiece according to [3] described above, in which
the second lens has a positive refractive power,
the third lens has a negative refractive power, and
the fourth lens has a positive or negative refractive power.
   [7]

The eyepiece according to [4] described above, in which
the second lens has a positive refractive power, and
the third lens has a negative refractive power.

The eyepiece according to [2] or [5] described above, in which each of the first lens, the second lens, and the third lens has a refractive index of 1.7 or greater with respect to a d-line.

[9]

The eyepiece according to [3] or [6] described above, in which each of the first lens, the second lens, the third lens, and the fourth lens has a refractive index of 1.7 or greater with respect to a d-line.

[10]

The eyepiece according to any one of [1] to [9] described above, in which a lens surface closest to the eye point in the three or more lenses has a convex shape.

[11]

The eyepiece according to any one of [1] to [10] described above, in which the following conditional expression is further satisfied,

0.78<f/(L−ER)<0.97 (3)
where “f” is an effective focal distance, and
“ER” is an eye relief.
   [12]

The eyepiece according to any one of [1] to [11] described above, in which the following conditional expression is further satisfied,

0.764<t′/L′ (4)
where “t” is a sum of center thicknesses of the respective three or more lenses, and
“L” is a distance from the lens surface closest to the eye point in the three or more lenses to the image.

A display apparatus provided with an image display device and an eyepiece that enlarges an image displayed on the image display device,
the eyepiece including three or more lenses provided in order from side of an eye point toward side of an image,
at least two of the three or more lenses configuring a cemented lens,
one of the three or more lenses being an aspherical lens, in which
the following conditional expressions are satisfied,

ω′/(tan⁻¹(h/L))≥2.2 (1)

ω′≥0.698 (2)
where “ω′” is a half value (rad) of a maximum field-of-view angle,
“h” is a maximum image height, and
“L” is a distance from the eye point to the image.

This application claims the benefit of Japanese Priority Patent Application JP2017-079778 filed with the Japan Patent Office on Apr. 13, 2017, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. An eyepiece comprising three or more lenses provided in order from side of an eye point toward side of an image,
at least two of the three or more lenses configuring a cemented lens,
one of the three or more lenses being an aspherical lens, wherein
the following conditional expressions are satisfied,
ω′/(tan⁻¹(h/L))≥2.2 (1)
ω′≥0.698 (2)
where “ω′” is a half value (rad) of a maximum field-of-view angle,
“h” is a maximum image height, and
“L” is a distance from the eye point to the image.

2. The eyepiece according to claim 1, wherein
the three or more lenses comprise
a first lens,
a second lens,
a third lens, and
a fourth lens
that are provided in order from the side of the eye point toward the side of the image,
the second lens and the third lens configure the cemented lens, and
the fourth lens is the aspherical lens.

3. The eyepiece according to claim 1, wherein
the three or more lenses comprise
a first lens,
a second lens,
a third lens, and
a fourth lens
that are provided in order from the side of the eye point toward the side of the image,
the second lens, the third lens, and the fourth lens configure the cemented lens, and
the first lens is the aspherical lens.

4. The eyepiece according to claim 1, wherein
the three or more lenses comprise
a first lens,
a second lens, and
a third lens,
that are provided in order from the side of the eye point toward the side of the image,
the second lens and the third lens configure the cemented lens, and
the first lens is the aspherical lens.

5. The eyepiece according to claim 2, wherein
the second lens has a positive refractive power, and
the third lens has a negative refractive power.

6. The eyepiece according to claim 3, wherein
the second lens has a positive refractive power,
the third lens has a negative refractive power, and
the fourth lens has a positive or negative refractive power.

7. The eyepiece according to claim 4, wherein
the second lens has a positive refractive power, and
the third lens has a negative refractive power.

8. The eyepiece according to claim 2, wherein each of the first lens, the second lens, and the third lens has a refractive index of 1.7 or greater with respect to a d-line.

9. The eyepiece according to claim 3, wherein each of the first lens, the second lens, the third lens, and the fourth lens has a refractive index of 1.7 or greater with respect to a d-line.

10. The eyepiece according to claim 1, wherein a lens surface closest to the eye point in the three or more lenses has a convex shape.

11. The eyepiece according to claim 1, wherein the following conditional expression is further satisfied,
0.78<f/(L−ER)<0.97 (3)
where “f” is an effective focal distance, and
“ER” is an eye relief.

12. The eyepiece according to claim 1, wherein the following conditional expression is further satisfied,
0.764<t′/L′ (4)
where “t” is a sum of center thicknesses of the respective three or more lenses, and
“L” is a distance from the lens surface closest to the eye point in the three or more lenses to the image.

13. A display apparatus provided with an image display device and an eyepiece that enlarges an image displayed on the image display device,
the eyepiece comprising three or more lenses provided in order from side of an eye point toward side of an image,
at least two of the three or more lenses configuring a cemented lens,
one of the three or more lenses being an aspherical lens, wherein
the following conditional expressions are satisfied,
ω′/(tan⁻¹(h/L))≥2.2 (1)
ω′≥0.698 (2)
where “ω′” is a half value (rad) of a maximum field-of-view angle,
“h” is a maximum image height, and
“L” is a distance from the eye point to the image.
